(19) United States
(12) Patent Application Publication
(10) Pub. No.: US 2023/0391171 A1
(43) Pub. Date: Dec. 7, 2023

(54) VEHICLE WITH A PLATFORM UNIT ON A BODYWORK OPENING

(71) Applicants: Brose Fahrzeugteile SE & Co. Kommanditgesellschaft, Bamberg, Bamberg (DE); Bode - Die Tür GmbH, Kassel (DE)

(72) Inventors: Christian GITTER, Zeil (DE); Lukas PANHANS, Neustadt bei Coburg (DE); Thomas FÖRSTER, Nürnberg (DE); Harald HUGEL, Bamberg (DE); Daniel MUSCHEL, Würzburg (DE); Jörg STÜBINGER, Mainleus (DE)

(21) Appl. No.: 18/249,711

(22) PCT Filed: Oct. 18, 2021
(86) PCT No.: PCT/EP2021/078813

§ 371 Date: Apr. 19, 2023

(30) Foreign Application Priority Data
Oct. 19, 2020 (DE) 10 2020 213 182.1

(51) Int. Cl. B60J 5/04; B60P 1/43

(52) U.S. Cl. CPC B60J 5/0473; B60J 5/0479; B60P 1/435; A61G 3/061

(57) ABSTRACT

It is provide a vehicle, comprising a bodywork opening, which can at least partially be closed by at least one door disposed in a closing position, and a flat platform unit, which is provided to facilitate access into the vehicle via the bodywork opening, when the at least one door is disposed in an opening position. At least part of the flat platform unit is formed by at least one adjustable, flat platform element, which forms part of the at least one door, which in the closing position closes at least part of the bodywork opening, or in at least one adjustment position, is fixed to and/or supported on a component of the at least one door.

### BACKGROUND

The proposed solution relates to a vehicle, comprising a bodywork opening at which easier access into the vehicle is possible via a flat platform unit.

From the prior art, and in particular from local public transport, vehicles with platform units for easier entry into and exit from a vehicle are widely known. Typically, these are manually or motorically extendable plates or ramps, by which a gap between an entry edge at the bodywork opening and a ground surface or an opposite curb or platform edge is to be bridged. Especially in connection with road vehicles, however, the possible uses and functionalities of such platform units regularly are limited. In addition, platform units at vehicles typically are arranged completely on a vehicle floor in order to be accommodated there in a retracted state. Possibly, however, this will then considerably increase the constructional expenditure when additional functions are to be provided via the platform unit, in particular when the platform unit is to be usable for example as part of a lifting device in order to make it easier for persons of reduced mobility to have access to the vehicle or to exit from the vehicle by means of an elevator. The demand for vehicles improved in this respect increases in particular in autonomously driving vehicles, as here no human vehicle operator necessarily must be present, who might support the handling of a platform unit.

### SUMMARY

A vehicle as described herein provides relief.

In particular, there is proposed a vehicle in which at least part of a flat platform unit, which is provided to facilitate access into the vehicle via a bodywork opening, is formed by at least one adjustable, flat platform element, which

forms part of at least one door provided for at least partially closing the bodywork opening, which in a closing position of the door closes at least part of the bodywork opening, or

in at least one adjustment position, is fixed to and/or supported on a component of the at least one door.

When the flat platform element according to the above variant a) forms part of the at least one door, which in the closing position closes at least part of the bodywork opening, the at least one door consequently is of multi-part (at least two-part) design and in addition to the platform element comprises at least one door leaf element, for example. When the platform element according to the above variant b) in at least one adjustment position of a component of the at least one door is fixed and/or supported thereon, the platform element can be adjusted between at least two different adjustment positions and, in at least one of these adjustment positions, is held or arrested for example at a component of the at least one door and/or in at least one of these adjustment positions, in particular during an adjusting movement between two adjustment positions, supported on the component.

Thus, it is an idea underlying the proposed solution to provide at least one flat platform element which at least also defines a treading and/or loading surface on at least one door of the vehicle, or to at least fix or support the same thereon in order to thereby integrate a function for the platform unit at the door. This not only allows to more easily increase a bandwidth of the functions to be provided via the platform unit. Rather, this also involves greater flexibility in the construction, when it is no longer necessary—as has frequently been usual in practice—to design all structural aspects of a platform unit independently of a (vehicle) door. Previously usual constructions above all are focused on avoiding an impairment of an adjusting movement of the vehicle door between a closing position and an opening position and in particular the alignment of the vehicle door in the opening position by a platform unit provided for facilitating an access into the vehicle.

Preferably, the at least one flat platform element of the proposed solution can be adjusted in a power-operated way, i.e. assisted and/or controlled by at least one drive motor, so that an adjusting movement of the platform element can be controlled electronically.

In principle, it can be provided to use the platform element (as part of the platform unit) for example as a step and/or as part of a lifting device and/or—in a tilted position—as a ramp that adjoins a lower entry edge at the bodywork opening and bridges a gap between the entry edge and a ground or a curb opposite the entry edge. The platform element or the platform unit at least partly formed therewith consequently is adapted and provided to provide a step and/or a part of a lifting device and/or a ramp at the bodywork opening. In one design variant, the at least one platform element additionally is adapted and provided for providing a transfer platform for the vehicle interior accessible via the bodywork opening, for example for packages or luggage, or for providing a drone landing surface.

In one design variant, the at least one platform element can be adjusted at least between a first adjustment position and a second adjustment position, wherein in the first adjustment position the platform element cannot be used to facilitate access into the vehicle, and via the platform element disposed in the second adjustment position a position of use of the platform unit is defined, in which the platform element can be used to facilitate access into the vehicle. Thus, the first adjustment position for example defines a rest or stowage position of the at least one platform element, while the platform element in its second adjustment position for example is disposed in a position of use.

In one design variant, the position of the platform unit, in particular its height and/or inclination with respect to a floor present in the vehicle interior of the vehicle, can be varied when the platform unit already is disposed in a position of use. A variation of the position of the platform unit hence involves an adjustment of the at least one platform element. The at least one platform element then for example can be adjusted into at least one third adjustment position, so as to be able to differently position the platform unit in its position of use. For example, via an adjustment of the at least one platform element from its first adjustment position into its second adjustment position, the platform unit can be folded out and/or extended at the bodywork opening so that the platform unit can be used to facilitate access into a vehicle interior. By adjusting the at least one platform element into a third adjustment position different therefrom, the position of the platform unit can then by varied by maintaining the basic usability of the platform unit. For example, tilting and/or lowering of the platform unit can be effected by adjusting the at least one platform element so that the platform unit can rest on a ground. Alternatively or additionally, an adjustment of the at least one platform element into the at least one third adjustment position can involve lifting of the platform unit, until an upper side of the platform unit substantially or exactly is flush with a front edge of a floor in the vehicle interior and hence with an entry edge at the bodywork opening or is higher than such a front edge. With a platform unit located at a higher level as compared to the front edge or entry edge of the vehicle, for example a drone landing surface or a transfer platform can be provided as part of a loading or unloading aid.

In a development, the platform unit includes a rear region that faces a front edge of a floor element provided in an interior space of the vehicle and adjoining the bodywork opening. In a front region, the platform unit can be supported on a ground present outside the vehicle via at least one support element. The at least one support element thus can contribute to stabilizing the platform unit in a front region of the platform unit remote from an entry edge of the bodywork opening. In particular, such a support element can be provided on a platform element disposed in the second adjustment position or on an additionally provided, foldable or extendable, flat auxiliary element of the platform unit.

For example, the support element includes a motor drive in order to vary the position, in particular the height, of the platform unit disposed in the position of use. This for example includes the fact that the support element is formed with a telescopically adjustable (and possibly motor-driven) support foot in order to be able to vary a height of the platform unit in a position of use. Alternatively or additionally, the support element can be provided with a toggle mechanism on the underside of the platform unit in order to support lifting of the platform unit according to the principle of a jack. Beside the provision of an additional support of the platform unit, the provision of an additional support element provided with a drive also can provide for easily varying the height of a platform unit loaded with an additional weight with respect to a floor element of the vehicle interior.

The at least one platform element in principle can be pivotable and/or translationally adjustable, in particular about and along different spatial axes. For example, the at least one platform element is pivotable about a pivot axis that extends parallel to a vehicle longitudinal direction pointing from a vehicle rear to a vehicle front or that extends perpendicularly to the vehicle longitudinal direction (and hence parallel to a vehicle transverse axis).

To provide a larger treading and/or loading surface at the platform unit, the platform unit can be formed by at least one flat auxiliary element in addition to the at least one platform element. Such a flat auxiliary element then for example is mounted on the at least one platform element so as to be pivotable and/or translationally adjustable. Then, for example, the auxiliary element in a state folded in or retracted can be adjusted from a first adjustment position into a second adjustment position along with the platform element, in particular in a power-operated way. Subsequently, an adjustment of the flat auxiliary element is effected with respect to the platform element remaining in the second adjustment position, in order to provide an increased treading and/or loading surface for the platform unit. Of course, what is also possible is a design variant in which the auxiliary element initially is adjusted with respect to the platform element or an adjustment of both elements is at least temporarily effected at the same time.

In one design variant, the at least one flat auxiliary element can be pivoted for example about a further pivot axis that extends parallel or perpendicularly to that pivot axis about which the at least one platform element can be pivoted. For example, for providing a treading and/or loading surface at the platform unit disposed in the position of use, the platform element and the auxiliary element (possibly also further platform and/or auxiliary elements) at the vehicle and here possibly in particular at the at least one door are folded up and/or down and/or extended. To subsequently again compactly stow the platform unit at the vehicle, an adjusting movement of the individual elements is effected in the reverse direction and/or in reverse order.

In one design variant, the platform unit in its position of use with a rear region faces an entry edge or a front edge of a floor element provided in an interior space of the vehicle and adjoining a bodywork opening. Furthermore, there is provided at least one holding element via which a front region of the platform unit, which is spaced apart from the rear region in a spatial direction pointing away from the front edge, is connected to the at least one door or to a frame structure of the vehicle bordering the bodywork opening. The front region of the platform unit consequently is stabilized here by at least one additional holding element, which provides an (additional) connection to the door or to a frame structure of the vehicle and hence can thereby introduce possible weight forces into the door or the frame structure of the vehicle. Then, the holding element thereby is configured to absorb tensile forces and for example comprises at least one band, at least one chain, at least one cable and/or at least one rod.

In a development, a portion of a holding element is held at a resiliently mounted, frame-side or door-side connecting part. Thus, an elastic displaceability of the holding element with respect to the vehicle-side frame structure or with respect to a part of the door here is specifically permitted, in particular in order to support the adjustability of the platform unit. When an auxiliary element is provided for forming the platform unit in the position of use, the at least one holding element can be connected to such an auxiliary element in the front region of the platform unit. Alternatively, the at least one holding element can be connected to the at least one platform element in the front region of the platform unit disposed in the position of use.

A stabilizing holding element in one design variant, alternatively or additionally, can be of the adjustable type for varying a position of the platform unit disposed in the position of use. For example, one end of the holding element therefor is articulated to the platform unit, while another end of the holding element—then typically longitudinally extended—is shiftably mounted on a frame-side guiding device of a frame structure of the bodywork opening or on a door-side guiding device. By shifting the end guided on the guiding device, a displacement of the platform unit can then be controlled.

In principle, the at least one platform element as part of the door or fixed to the door can be co-displaceable when the door is adjusted from its closing position into its opening position. A co-displacement of the at least one platform element here can always be effected during an adjustment of the door. In one design variant, a possible co-displacement of the at least one platform element is dependent on a coupling state or one adjustment mode out of several (at least two) possible adjustment modes for the door. In the latter case, the at least one platform element then can selectively be adjustable along with a door leaf element of the door or separately from the same.

In one design variant, the bodywork opening can be closed by at least two doors. For example, two doors pivotable or shiftable in opposite directions can be provided at the bodywork opening. To each of the at least two doors one of at least two platform elements can be associated, which then each form part of the platform unit (when the platform elements have correspondingly been adjusted in order to define a fragmented or coherent treading and/or loading surface for the position of use of the platform unit).

In one design variant, the platform element which in the closing position of the at least one door closes at least part of the bodywork opening is adjustable separately from at least one flat door leaf element of the door, which in the closing position closes at least part of the bodywork opening together with the platform element. Here, the door consequently is of multi-part design and also comprises a flat door leaf element beside the flat platform element. In the closing position of the door, both elements of the door (door leaf element and platform element) jointly close the bodywork opening at least in part and each define part of a door outer skin at the body of the vehicle.

In a design variant based thereon, the door leaf element, based on a vehicle height direction pointing from a vehicle floor to a vehicle roof of the vehicle, is provided as an upper part of the at least one door, while the platform element forms a lower part of the at least one door. For providing the platform unit, the at least one platform element then can be downwardly adjustable with respect to the vehicle height direction with at least one directional component, while the door leaf element is separately adjustable sidewards on the vehicle, upwards or transversely to the vehicle height direction. Thus, to clear the bodywork opening, the door leaf element is adjusted sidewards (possibly superimposed with one or more pivotal movements) upwards or parallel to a vehicle longitudinal direction. A corresponding adjusting movement of the door leaf element involves a downward adjustment of the at least one platform element with respect to the vehicle height direction in order to define a treading and/or loading surface of the platform unit.

In particular in a design variant explained above, the platform element can be adjustable into a stowage space position, in which the platform element at least partially is disposed below a vehicle-side floor element, which defines a floor surface of an interior space of the vehicle. In the stowage space position, the at least one platform element correspondingly can at least partially be disposed between a ground or a roadway and a vehicle underbody of the vehicle or in a floor-side stowage space below the floor surface.

A door leaf element of the at least one door can be pivotable about at least one pivot axis in order to at least partially clear the bodywork opening. This in particular includes pivoting of the door leaf element beyond an edge of a vehicle.

In one design variant, the at least one platform element can also be pivotable in one adjustment mode (of at least two possible adjustment modes) when coupled to a door leaf element, in order to at least partially clear the bodywork opening. The platform element and the door leaf element then consequently are displaceable in a first adjustment mode, when coupled to each other, in order to specify an opening position of the door in which the vehicle interior is accessible, without an entry and/or exit aid being provided at the bodywork opening via the platform element. In a second adjustment mode, the at least one platform element on the other hand is decoupled from the door leaf element and can be displaced separately to provide the entry and/or exit aid.

In another design variant, the at least one platform element
b1) in the closing position of the at least one door, is fixed in a first adjustment position of a component of the at least one door and can be adjusted from the first adjustment position into a second adjustment position in order to thereby provide a treading and/or loading surface of the platform unit, or
b2) in the opening position of the at least one door, is (physically) guided on a guiding device of a component of the at least one door and can be adjusted when supported thereon.

In each of these variants, the platform element can be adjustable via a guiding device provided at the door, when the door is disposed in its opening position. Via such an adjustment it is possible for example to set the position, in particular the height with respect to an entry edge and/or the inclination of the platform unit or of a treading and/or loading surface provided with the same, in particular electronically controlled by means of at least one drive motor. This in particular includes the fact that the platform element can be adjusted along a vehicle height direction via the guiding device, in order to provide a lifting device in the form of a lifting platform at the bodywork opening by means of the platform unit. At the guiding device, for example, there can at least be provided a rotatable drive spindle that can be rotated for a power-operated adjustment of the platform unit via at least one drive motor.

In another design variant, the platform element can be extended from a vehicle-side stowage space transversely to a vehicle longitudinal direction of the vehicle pointing from a vehicle rear to a vehicle front. Via at least one guiding device at the door disposed in the opening position, the platform element can then be supported when the platform element is extended from the vehicle-side stowage space transversely to the vehicle longitudinal direction. In such a design variant, the platform element consequently can be translationally extended to the outside (possibly superimposed with a pivotal movement) at an entry edge of the bodywork opening, wherein the extending platform element is physically supported and guided on the door disposed in an opening position, and hence the extended platform element is also stabilized by the door.

In another design variant, the platform element on the other hand can be extended from a door-side stowage space parallel to a vehicle longitudinal direction of the vehicle pointing from a vehicle rear to a vehicle front. Via at least one guiding device at the door disposed in the opening position, the platform element here can be supported when the platform element is extended from the door-side stowage space parallel to the vehicle longitudinal direction. For example, the guiding device is configured with a foldable or extendable guide arm that integrates a guide rail for the platform element. In a development of this design variant, the platform element is of multi-part design comprising a plurality of segments which in an extended state are located one behind the other parallel to the vehicle longitudinal direction in order to define a coherent treading and/or loading surface of the platform unit. In a retracted state, the plurality of segments are arranged one above the other within the door-side stowage space so as to save space.

When at least two doors are used for closing the bodywork opening, a design variant of the proposed solution provides that to a first door of the at least two doors a first platform element is fixed, and to a second door of the at least two doors a second platform element is fixed. The first and second platform elements here can each be adjusted from a respective first adjustment position into a second adjustment position, in which the first and second platform elements are coupled to each other to form the platform unit. Thus, in the second adjustment position the first and second platform elements not only define a preferably coherent treading and/or loading surface for a position of use of the platform unit, but are also mechanically connected to each other in order to increase the stability of the platform unit disposed in the position of use. In particular, the first and second platform elements here can be adapted to be interlocked to form the platform unit, for example via meshing locking linkages.

For example, the first and second platform elements are pivotable towards each other to form the platform unit of the two associated doors, when the two doors each are disposed in the respective opening position. In a development, the platform elements pivoted towards each other and coupled with each other are also height-adjustable so that a platform unit formed by the two platform elements and its treading and/or loading surface, respectively, can be varied in its height in front of the bodywork opening. In such a variant, mutually opposite door leaf elements of the swung-out doors, relative to which the height of the platform unit can be set, can also provide visual protection and collision protection for persons entering or exiting via the platform unit.

In a variant with two doors for at least partially closing the bodywork opening, the platform element is pivotally mounted at a first door, while no platform element is provided at the second door. The second door without a platform element can, however, at least serve the support of the platform unit and/or the adjustability of the platform unit. For example, at least one adjustment element adjustable in a power-operated way is provided at the door without a platform element, via which the platform unit can be adjusted along the vehicle height direction. For example, below the entry edge of the bodywork opening a protruding, longitudinally extended support element can be provided, on which the platform unit rests in its position of use. This support element now can be adjustable via at least one adjustment element adjustable in a power-operated way, independently of whether or not a platform element is pivotally mounted at the door.

Another aspect of the proposed solution relates to a vehicle in which at least part of a flat platform unit is formed by at least one adjustable, flat platform element which, based on a vehicle height direction pointing from a vehicle floor to a vehicle roof of the vehicle, can be adjusted into an adjustment position above the front edge of a floor element present in the vehicle interior and adjoining the bodywork opening.

According to this aspect of the proposed solution, the platform unit with the at least one platform element consequently can be adjusted upwards beyond an entry edge at the bodywork opening. This in particular includes the fact that the platform unit can be adjusted upwards along the vehicle height direction beyond the entry edge over a lower third or up to one half of the height of the bodywork opening. This is particularly advantageous with regard to the provision of a drone landing surface and/or a transfer platform by the platform unit.

### BRIEF DESCRIPTION OF THE DRAWINGS

The attached exemplary embodiments show possible variants of the proposed solution. Aspects of the individual variants can also be combined with each other.

FIGS. 1A to 1C show a first design variant of a proposed vehicle with an individual, multi-part door in which a lower door part is formed by a flat platform element to provide a platform unit at a bodywork opening.

FIGS. 2A-2F show another design variant of a proposed vehicle comprising a multi-part door with the platform element in different adjustment positions.

FIGS. 3A-3D show developments of the design variant of FIGS. 2A to 2F, comprising a segmented roof part and an auxiliary element additionally extendable on the platform element.

FIG. 4 shows the vehicle of FIGS. 2A to 2F in a sectional representation.

FIG. 4A shows an enlarged detail representation of the area of FIG. 4 designated with “A”.

FIG. 5 shows a partly sectional side view of the vehicle.

FIG. 5A shows an enlarged detail representation of the area of FIG. 5 designated with “A”.

FIGS. 6A-6G show various views of different adjustment positions of a platform element and a door leaf element in another design variant of a proposed vehicle, in which a support element comprising a toggle mechanism is provided at an extendable auxiliary element of a platform unit.

FIGS. 7A-7D show a design variant of a proposed vehicle by illustrating different phases on opening of two door leaves of a double door.

FIGS. 8A-8D in views corresponding with FIGS. 7A to 7D, show a possible development in which an additional pivotal movement is provided for an opening movement of the doors of the double door.

FIGS. 9A-9C show a development of a vehicle according to the variant of FIG. 7A to 7D or 8A to 8D, in which holding elements for a platform unit folded out are each formed by door leaf elements of the doors.

FIGS. 10A-10C show a development on the basis the design variant of FIGS. 7A to 7D and 8A to 8D, in which holding elements separate from the door leaf elements are provided for the platform unit.

FIGS. 11A-11D show another variant by illustrating auxiliary elements to be folded out for increasing a treading and/or loading surface of a platform unit disposed in the position of use.

FIGS. 12A-12D show another design variant of a proposed vehicle, in which on two doors of the vehicle to be swung open in opposite directions one platform element each is provided for forming a platform unit, which in a position of use of the platform unit are interlocked and height-adjustable.

FIGS. 13A-13B show the design variant of FIGS. 12A to 12D with the platform unit in a tilted position so that a ramp for easier entry into and easier exit from the vehicle is defined thereby.

FIGS. 14A-14E show another design variant based on the variant of FIGS. 12A to 12D, in which additional support elements are provided on the platform unit.

FIG. 15 shows a side view of a door of the design variant of FIGS. 14A to 14E.

FIGS. 16A-16E show another design variant based on the variant of FIGS. 12A to 12D, in which the platform unit disposed in the position of use is held on door-side guiding devices by means of additional holding elements in the form of rods.

FIGS. 17A-17E in views corresponding with FIGS. 16A to 16E, show a variant in which instead of the rods flexible holding elements are used, for example each in the form of a cable, a chain or a band.

FIG. 18 sectionally and in a side view, shows a door of the design variant of FIGS. 17A to 17E.

FIGS. 19A-19F show another design variant with platform elements to be folded out laterally on two doors to be swung open in mutually opposite directions.

FIGS. 20A-20F in views corresponding with FIGS. 19A to 19F, show another variant comprising a differently foldable platform unit.

FIGS. 21A-21F show another design variant of a proposed vehicle, in which a foldable platform element merely is provided on one of two doors for closing a bodywork opening.

FIGS. 22A-22E show another design variant of a proposed vehicle, in which a platform element of a platform unit can be extended in the vicinity of a vehicle floor and furthermore is supported on the door side both during extension and in an extended state, and is height-adjustable and tiltable in an extended state.

FIGS. 22F-22H show various views concerning details of the design variant of FIGS. 22A to 22E.

FIGS. 23A-23B sectionally show another design variant of a proposed vehicle, in which an extendable platform unit is formed by a segmented platform element that can be stowed at a door to be swung open.

### DETAILED DESCRIPTION

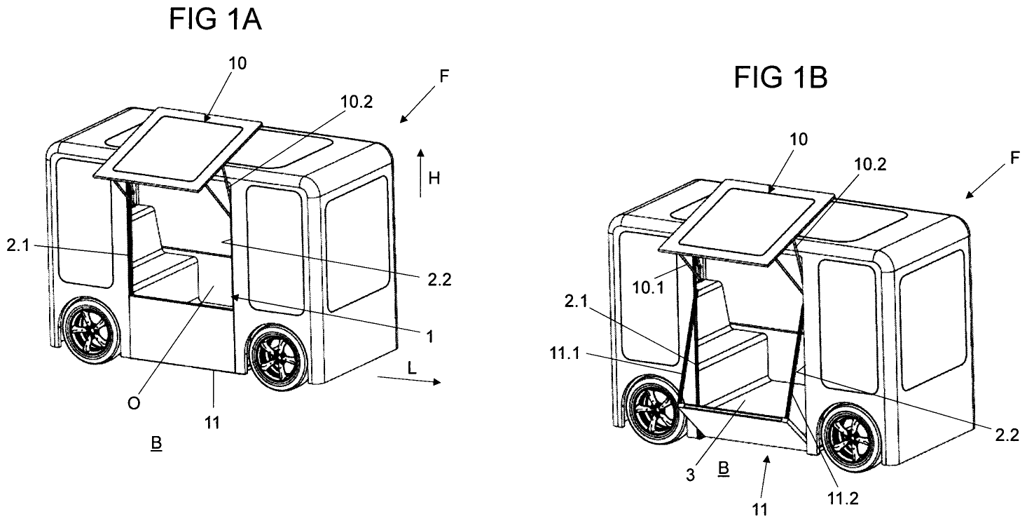

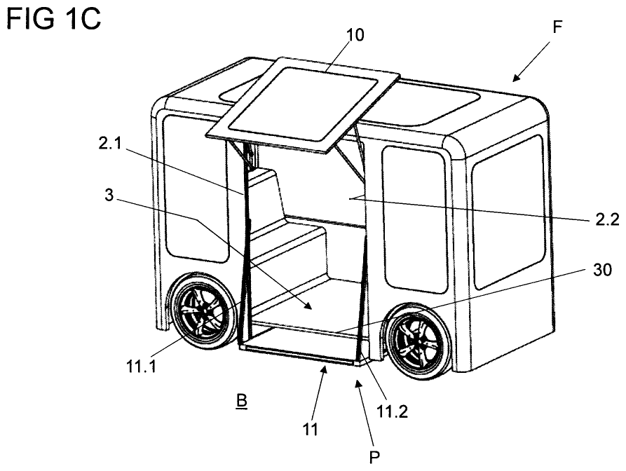

FIGS. 1A to 1C illustrate a first design variant of a proposed vehicle F, which here is configured as a road vehicle, in particular as an autonomously driving road vehicle. The vehicle F is provided with a bodywork opening O that can be closed by a vehicle door 1, which here is formed in two parts. An upper part of the door 1 is formed by a door leaf element 10, which for opening the vehicle door 1 can be folded upwards beyond a roof edge of a vehicle roof of the vehicle F. A lower part of the door 1 is formed by a flat platform element 11. When the door 1 is closed, this platform element 11 forms part of a door outer skin on the vehicle F. Furthermore, the platform element 11 can be folded down separately from the door element 10, based on the vehicle height direction H, in order to provide a platform unit P comprising a treading and/or loading surface for easier access to the vehicle.

The flat platform element 11 is adjustably held on the body of the vehicle F via longitudinally extended holding elements 11.1 and 11.2, for example in the form of rods, on door frame-side guide rails 2.1 and 2.2. The guide rails 2.1 and 2.2 each form part of a lateral frame structure that borders the bodywork opening O. On the guide rails 2.1 and 2.2 drive spindles are provided, which for example can be put into rotation by a motor, in order to pivot the platform element 11 downwards and the door leaf element 10 upwards when the bodywork opening O is to be made accessible.

In a lowered position of the platform element 11, in which a position of use of the platform unit P is defined, the treading and/or loading surface defined therewith protrudes adjacent to a front edge 30 of a floor element 3 provided in the vehicle interior and hence adjacent to an entry edge of the bodywork opening O. Via the platform element 11 thus lowered in the direction of a ground B, entry of a person into the vehicle F and, vice versa, exit of a person from the vehicle F can be made easier.

For upwardly or downwardly adjusting the door leaf element 10 (for closing the door 1), the door leaf element 10 is connected to guide elements 10.1 and 10.2, for example in the form of linkages, which likewise are shiftably held on the guide rails 2.1 and 2.2 of the lateral frame structures in a power-operated way.

In the design variant of FIGS. 1A to 1C, the platform element 11 in the present case can be folded down not only from a closing position of the door 1, but in addition can also at least partly be retracted below the floor element 3, in order to provide a gap-free transition at the bodywork opening O between the treading and/or loading surface provided via the platform unit P in its position of use and the entry edge defined by the front edge 30 of the floor element 3. Moreover, by partly retracting the platform element 11 below the floor element 3, the size of the provided treading and/or loading surface can also be limited to a size that is smaller than a side surface of the platform element 11, which faces the vehicle interior when the door 1 is closed.

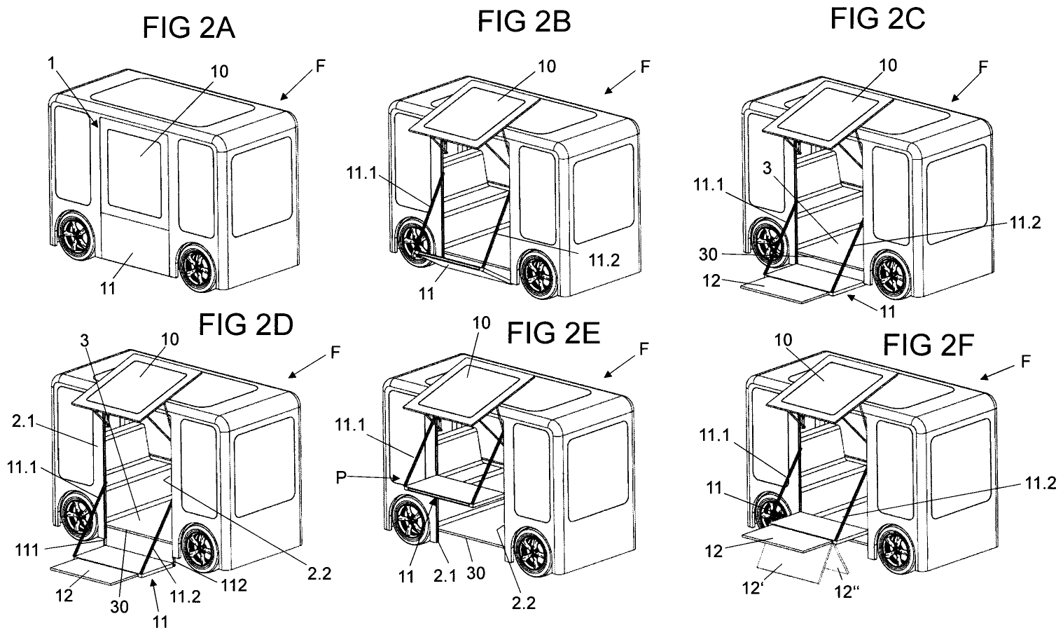

Corresponding to the development of FIGS. 2A to 2F, the flat platform element 11 can also be height-adjustable in its height with respect to the front edge 30 and hence the entry edge of the bodywork opening O, after being folded open. The platform element 11 therefor is shiftably mounted along the vehicle height direction H in its rear region via adjusting slides 111 and 112 on the mutually opposite guide rails 2.1 and 2.2 of the lateral frame structures of the bodywork opening O. In this way, the platform element 11 and the platform unit P defined therewith, which comprises the horizontal treading and/or loading surface, can be adjusted in its height with respect to the entry edge of the bodywork opening O. In the present case, the platform unit P here can also be positioned distinctly above the entry edge so as to provide a drone landing surface and/or a transfer platform for loading or unloading objects into or from the vehicle interior. The guide rails 2.1 and 2.2 therefor can extend over a large part of the total height of the bodywork opening O.

In the design variant of FIGS. 2A to 2F, a flat auxiliary element 12 furthermore is translationally adjustably mounted on the flat platform element 11. This auxiliary element 12 can be extended on the platform element 11 in order to increase the treading and/or loading surface provided in the position of use of the platform unit P.

As is illustrated with reference to FIG. 2F, the auxiliary element 12 in an alternative embodiment can also be provided on the platform element 11 so as to be folded out. The auxiliary element 12 then for example can be folded beyond the adjustment positions designated with 12′ and 12″ in FIG. 2F into a position folded out, in order to increase the treading and/or loading surface.

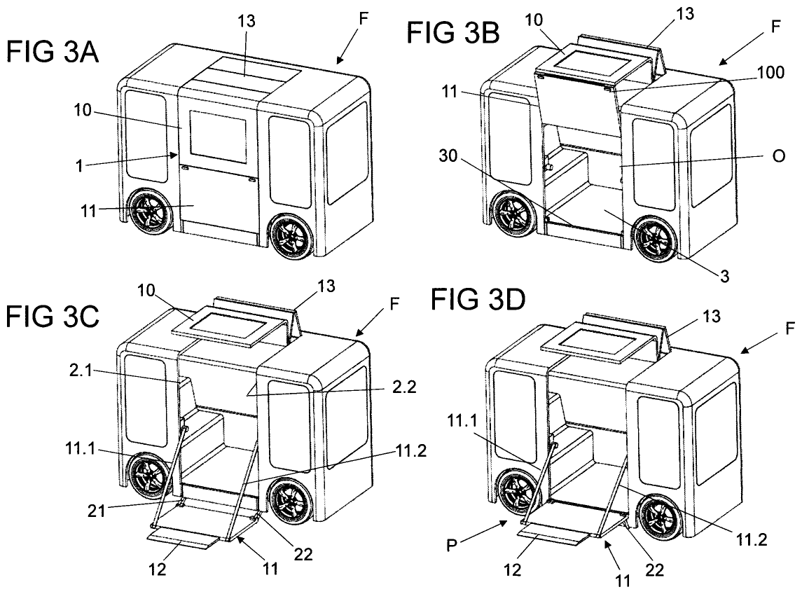

In the design variant of FIGS. 3A to 3D, the flat platform element 11 again includes a flat auxiliary element 12 at its front edge, which can additionally be extended, if necessary. In addition, an articulated lever assembly comprising articulated levers 21 and 22 is provided for stabilizing the platform unit P in a position of use possibly terminating flush with the entry edge and for allowing the platform unit P to be lowered in the direction of the ground B. Via the articulated levers 21 and 22, the flat platform element 11 of the platform unit P is held on the guide rails 2.1 and 2.2 in a rear region. In a front region, the horizontal position of use of the platform unit P is again stabilized via holding elements 11.1 and 11.2 shiftably held on the guide rails 2.1 and 2.2, in the present case formed by two (connecting) rods articulated to the platform element 11.

In the design variant of FIGS. 3A to 3D, in deviation from the design variants explained above, the door leaf element 10 also is articulated to a segmented roof part 13 of the vehicle F. In this way, the door leaf element 10 not only can be pivoted about a pivot axis extending parallel to a vehicle longitudinal direction L, in order to clear the bodywork opening O. In addition, segments of the roof part 13 rather also are pivotable and foldable in order to create additional space towards the top, when the door is opened and the bodywork opening O hence is cleared.

Furthermore, depending on the chosen adjustment mode of the door 1, the platform element 11 either can be adjusted towards the top together with the door leaf element 10, without a platform unit P consequently being provided as an entry or exit aid, or can be adjusted at a coupling interface 100 separately from the door leaf element 10. In the latter case, the platform element 11 thus can be adjusted downwards separately from the door leaf element 10 in order to provide the treading and/or loading surface in front of the entry edge of the bodywork opening O.

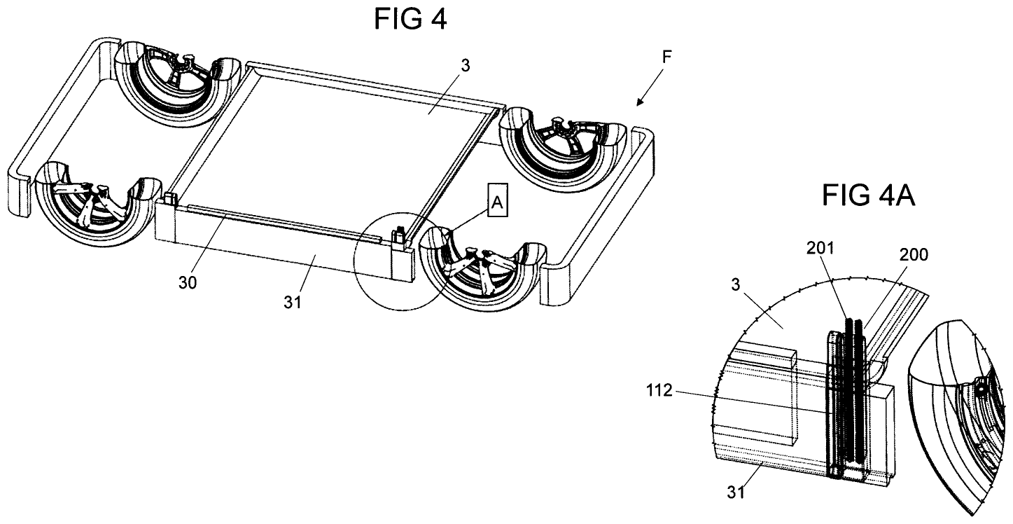

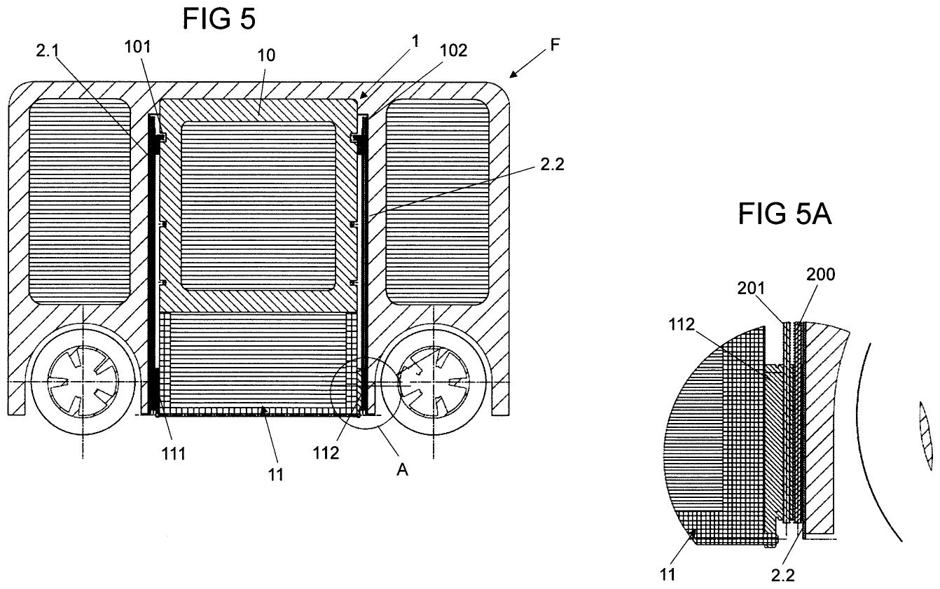

FIGS. 4 and 4A illustrate different views of a structure of an adjusting mechanism for the adjustment of the platform element 11 and of the door leaf element 12, which can be applied e.g. in the design variants of FIGS. 1A to 1C and 2A to 2F. Further details are shown in FIGS. 5 and 5A.

On the lateral guide rails 2.1 and 2.2 of the lateral frame structures, there is each provided a drive device comprising drive elements in the form of drive spindles 200 and 201. A drive spindle 200 together with an adjustment element in the form of an adjusting slide 101 or 102 meshing with the drive spindle 200 and longitudinally shiftably mounted on the respective guiding device 2.1 here performs the adjustment of the door leaf element 10. Via a further drive spindle 201 and an adjusting slide 111 or 112 each meshing with the respective guide rail 2.1 or 2.2, the power-operated and electronically controllable adjustment of the platform element 11 is effected.

The adjusting slides 111, 112 of the platform element 11, which are provided on both sides of the lateral frame structure of the bodywork opening O, here in particular can also be shifted to below the front edge 30 on the floor element side and hence to below the entry edge of the bodywork opening O in a trim 31. In this way, the platform element 11 in the state folded out (and hence the platform unit P in its position of use) can be also be set in its height by means of the drive spindle 201 and can be adjusted to below the entry edge.

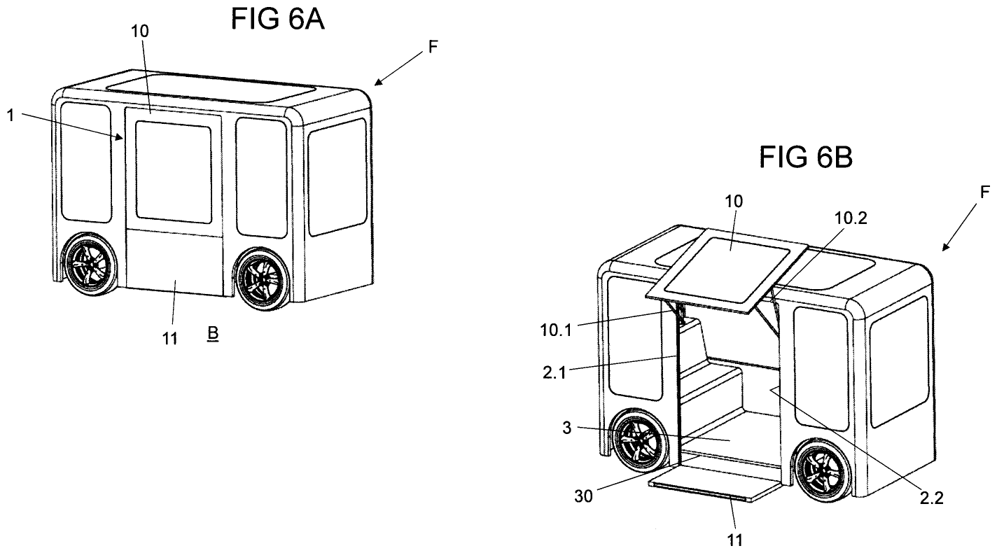

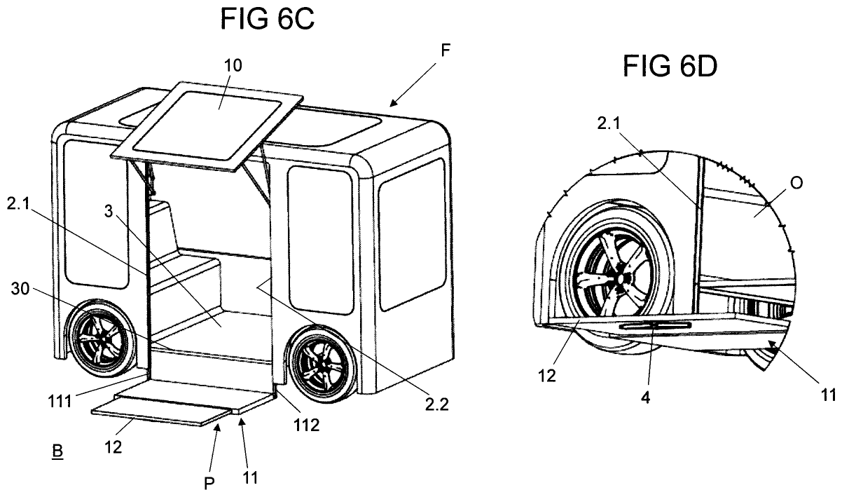

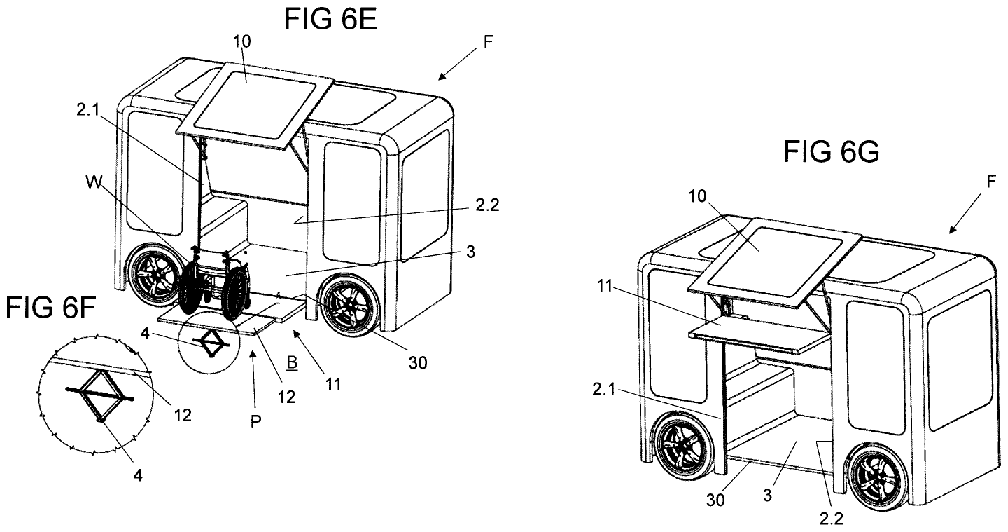

In the development of FIGS. 6A to 6G, an additional support member 4 is provided on the translationally extendable auxiliary element 12 of the platform unit P on an underside facing the ground B. Via this additional support member 4, a barrier-free access to the vehicle F is further supported. The support member 4 integrates a toggle mechanism that can be supported on the ground B. By actuating the toggle mechanism, the support member 4 then can support lifting of the platform unit P when comparatively much weight rests on the provided treading and/or loading surface, for example the weight of a wheelchair W shown in FIG. 6E. So, the platform unit P initially can be completely lowered onto the ground B. Subsequently, the platform unit P is lifted via the spindle drives on the guide rails 2.1 and 2.2. Lifting can now be assisted by the support member 4 on the extended auxiliary element 12, in that the toggle mechanism of the support member 4 also is driven by a motor.

In principle, in one design variant, the toggle mechanism of the support member 4 also allows to omit the holding elements 11.1 and 11.2, as the highest loads can be lifted up to the entry height by means of the toggle mechanism and lower loads are vertically movable via the adjusting slides 111, 112 alone in the entry area.

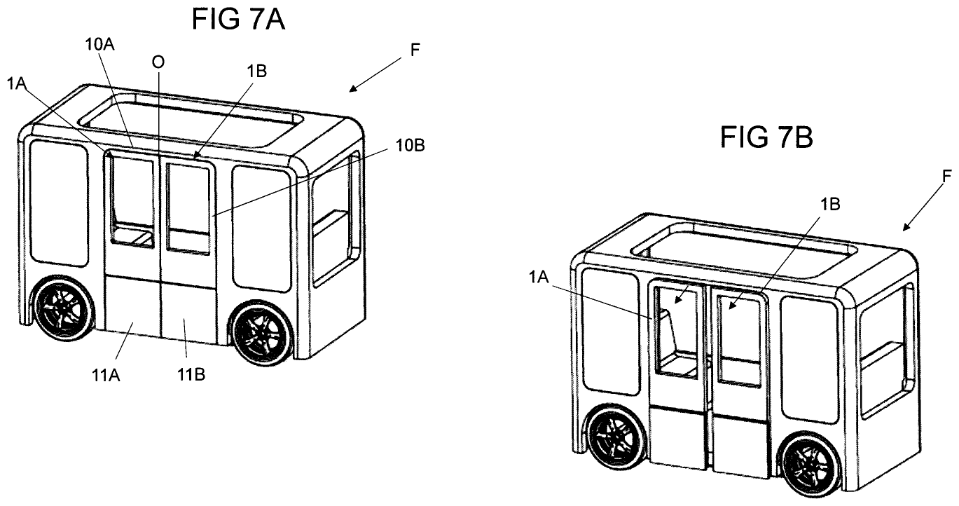

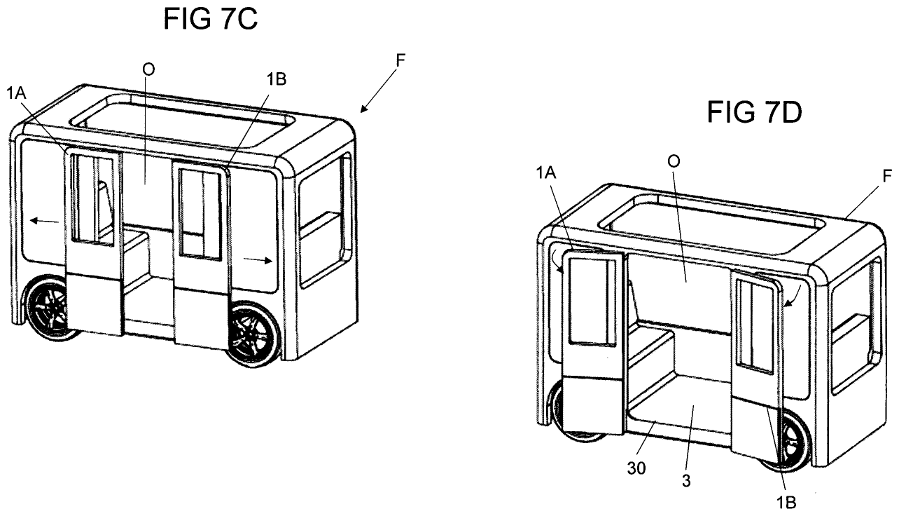

When an individual multi-part door 1 is provided in the design variants of FIGS. 1A to 6G for closing the bodywork opening O, FIGS. 7A to 7D by way of example show a design variant of a proposed vehicle F, in which the bodywork opening O can be closed by a double-leaf double door. Consequently, there are provided two doors 1A and 1B adjustable in mutually opposite directions. In the present case, each of these doors 1A, 1B is formed in two parts each comprising a door leaf element 10A or 10B as well as a flat platform element 11A or 11B. In the variant of FIGS. 7A to 7D, the doors 1A and 1B can be adjusted in mutually opposite directions via a pushing movement and subsequently can be pivoted to the outside in mutually opposite directions in order to clear the bodywork opening O.

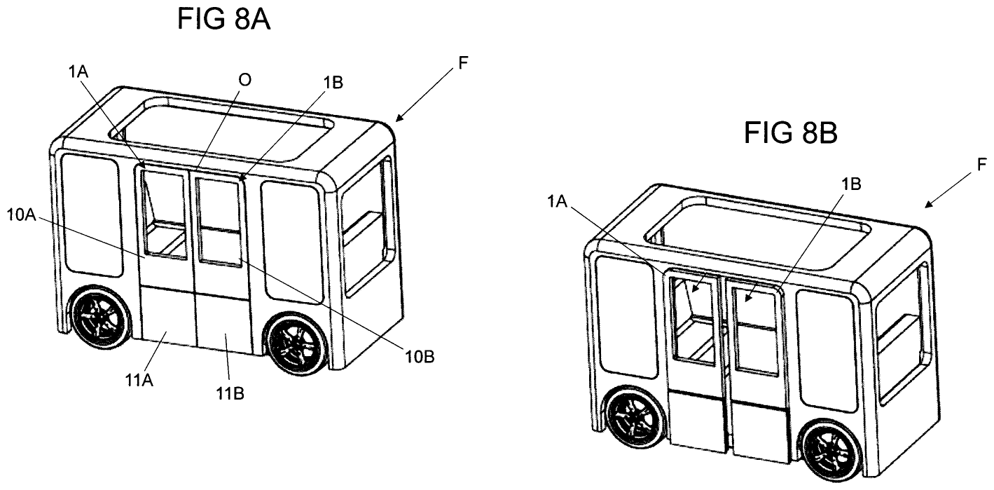

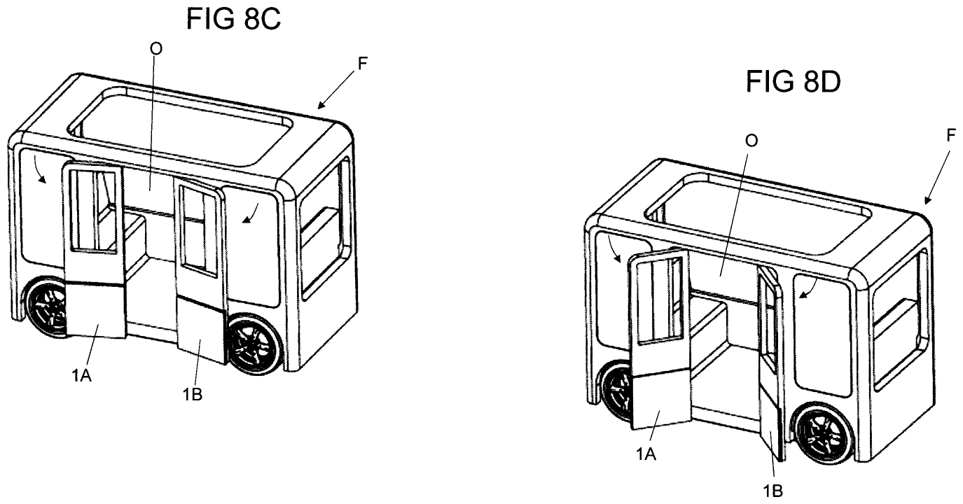

In a variant illustrated by way of example with reference to FIGS. 8A to 8D, the doors 1A and 1B can perform a combined pushing-pivoting movement in order to be adjusted between the opening and closing positions.

In the end independently of the adjusting movements via which the doors 1A and 1B can be opened and closed in a first adjustment mode, without a platform unit P being provided at the entry edge of the bodywork opening O, different design variants can be realized on the basis of the proposed solution, in which in a second adjustment mode the respective platform elements 11A and 11B can be adjusted independently of the door leaf elements 10A and 10B, in order to provide a platform unit P. The platform elements 11A and 11B here are attached to the outside of the respective door. Furthermore, the doors 1A and 1B not only can turn open, but slide open or slide open and turn open in a superimposed manner. As compared to the variants discussed above, a different and regularly smaller opening area or swivel space therefore is required.

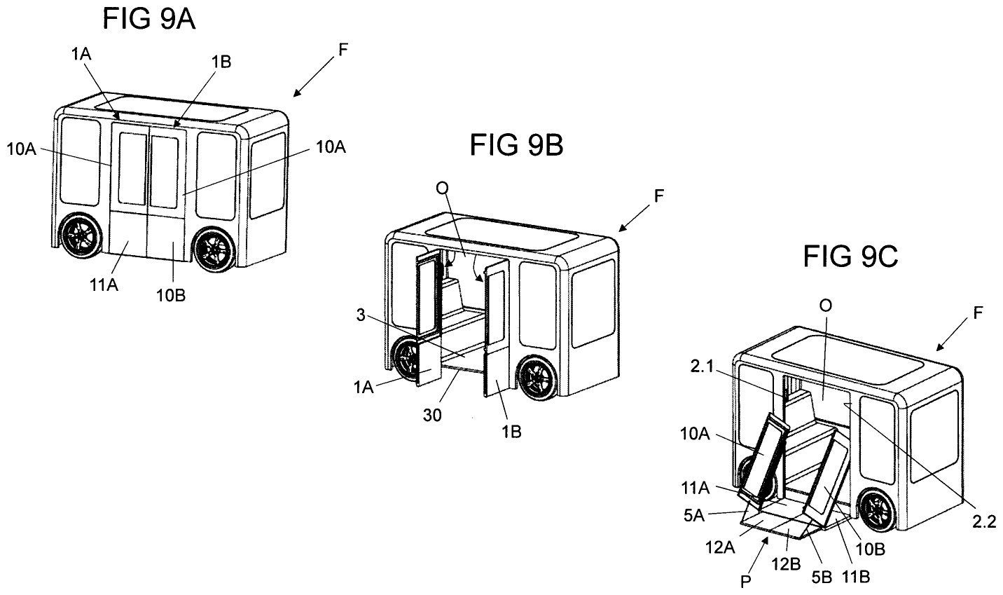

In the design variant of FIGS. 9A to 9C, for example, the doors 1A and 1B are swung open in mutually opposite directions so that the insides of the doors 1A and 1B, which in a closing position face the vehicle interior, face each other when the doors 1A and 1B are open. Proceeding from this opening position, the lower parts of the doors 1A and 1B in the form of the platform elements 11A and 11B now can be folded towards each other and hence be interlocked in order to thereby provide a treading and/or loading surface of a platform unit P. Proceeding from a first adjustment position corresponding to FIG. 9B, the platform elements 11A and 11B consequently can now be folded out towards each other about a pivot axis extending transversely to the vehicle longitudinal direction L into a respective second adjustment position. In this variant, the doors 1A and 1B or the door leaves defined therewith consequently are not turned over the roof, but adjusted on the vehicle long side via a pushing-pivoting unit. In addition, extendable auxiliary elements 12A and 12B can be provided on the platform elements 11A and 11B in order to increase the treading and/or loading surface.

For stabilizing the platform unit P folded out, the door leaf elements 10A and 10B can be tilted so that a connection between a portion of the platform unit P remote from the entry edge to a guide rail 2.1 or 2.2 of the lateral frame structures of the bodywork opening O thereby is provided.

For the additional support of the extended auxiliary elements 12A and 12B exposed to a tensile load, the connecting elements 5A and 5B can be provided. These connecting elements 5A and 5B each engage an extended auxiliary element 12A or 12B and connect the same to the tilted door leaf element 10A or 10B. Via the tilted door leaf elements 10A and 10B as well as the additional connecting elements 5A and 5B, the platform elements 11A and 11B as well as the auxiliary elements 12A and 12B translationally extendable thereon to the outside consequently are held and stabilized in the position of use of the platform unit P.

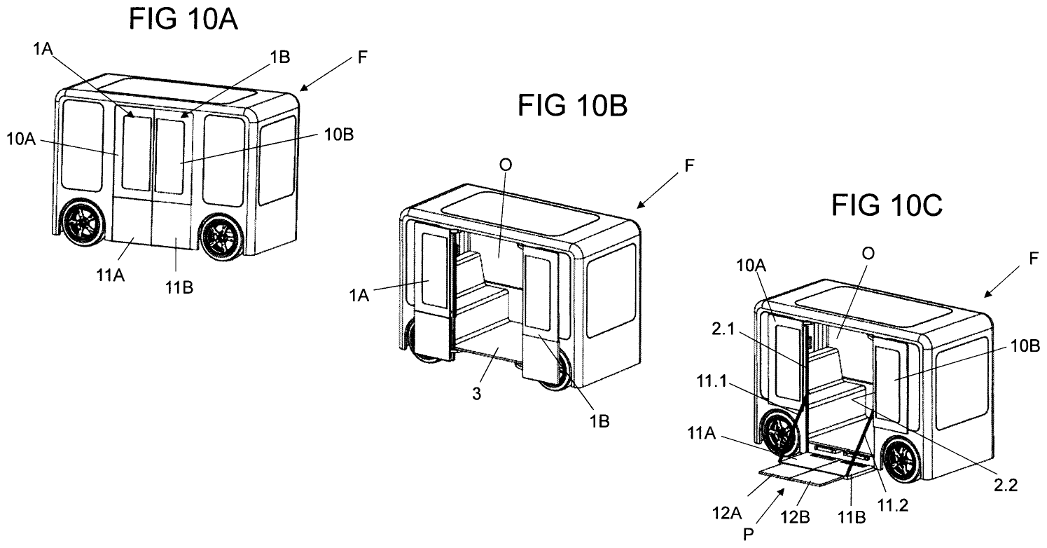

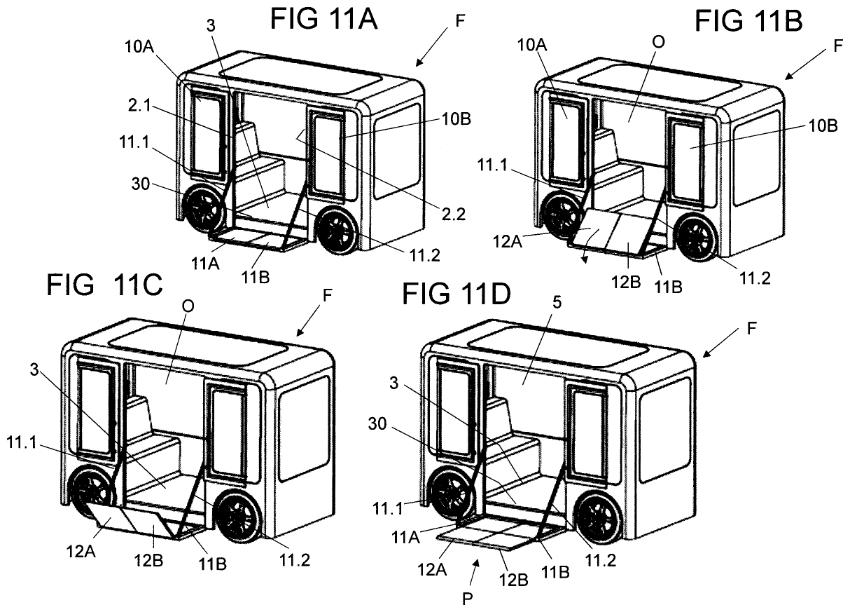

As is illustrated with reference to the exemplary embodiments of FIGS. 10A to 10C and 11A to 11D, tilting of the door leaf elements 10A or 10B need not necessarily be provided for the stabilization of the position of the platform elements and auxiliary elements 11A, 11B, 12A and 12B folded out or extended as explained above. Alternatively, as also already explained above, the use of separate holding elements 11.1 and 11.2 can be provided, for example.

With reference to the design variant of FIGS. 10A to 10C. it here is illustrated how the door leaf elements 10A and 10B can be adjusted on the one hand towards each other in mutually opposite sideward directions together with the platform elements 11A and 11B in order to clear the bodywork opening O. On the other hand, merely the door leaf elements 10A and 10B can be adjusted in mutually opposite sideward directions, while the platform unit P is provided in front of the entry edge of the bodywork opening O via the respective lower parts of the doors 1A and 1B in the form of the platform elements 11A and 11B. When correspondingly folded out towards the front, a front region of the respective platform elements 11A and 11B and hence of the platform unit P remains connected to the guide rails 2.1 and 2.2 via the holding elements 11.1 and 11.2 formed with rods. The maintenance of a horizontal alignment of the treading and/or loading surface also is supported thereby when the platform unit P in its position of use is adjusted in its height with respect to the entry edge.

In addition to the design variant of FIGS. 10A to 10D, FIGS. 11A to 11D illustrate the folding out of the additional flat auxiliary elements 12A and 12B about a pivot axis parallel to the vehicle longitudinal direction L on the respectively associated platform elements 11A and 11B, when the platform elements 11A and 11B have already been folded down.

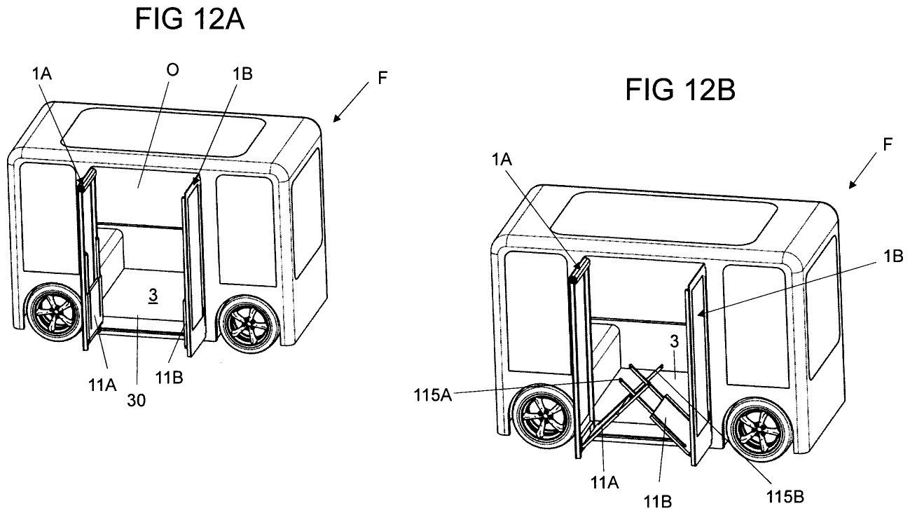

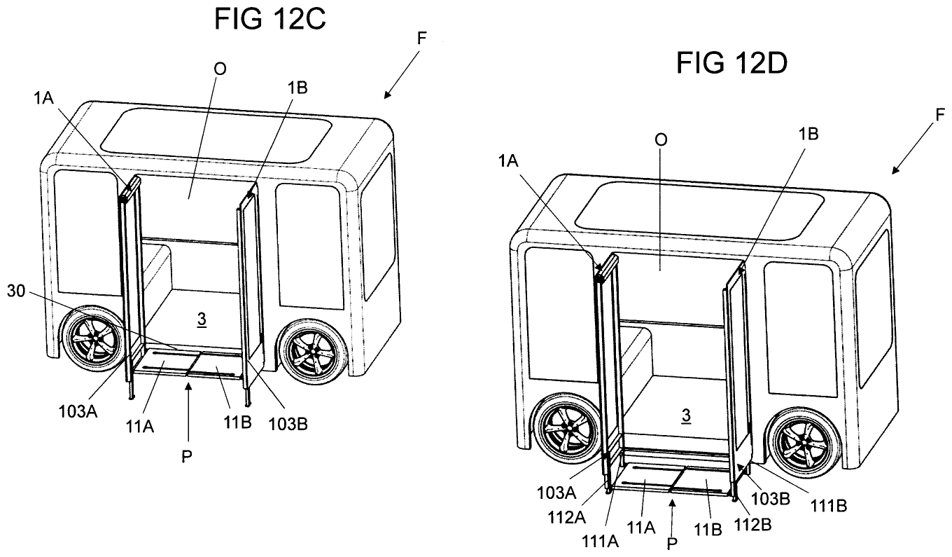

In the design variant of FIGS. 12A to 12D two doors 1A and 1B to be swung open in mutually opposite directions are again provided. Then, however, a platform element 11A or 11B of the respective door 1A or 1B in a closing position of the respective door 1A or 1B then is not used to close the bodywork opening O. At the respective door 1A, 1B this is effected solely by a door leaf element 10A or 10B of continuous design. On the inside of the respective door leaf element 10A or 10B a platform element 11A or 11B is fixed and pivotally mounted.

As is illustrated with reference to FIGS. 12A to 12D, the doors 1A and 1B in this design variant initially are swung open in mutually opposite directions so that their insides face each other. Then, if necessary, the platform elements 11A and 11B can each be folded towards each other by the mutually opposite door leaf elements 10A and 10B about pivot axes parallel to each other, which extend transversely to the vehicle longitudinal direction L. The size and distance of the platform elements 11A and 11B here are dimensioned in such a way that the platform elements 11A and 11B folded down and hence taking a second adjustment position define a continuous treading and/or loading surface between the two open doors 1A and 1B. Hence, a platform unit P is formed between the door leaf elements 10A and 10B. In such a variant, the mutually opposite door leaf elements 10A, 10B of the doors 1A and 1B swung open also provide a visual protection and collision protection for persons entering or exiting via the platform unit P.

For an additional stabilization of the position of use of the platform unit P specified thereby, the two platform elements 11A and 11B folded down are positively and/or cohesively interlocked via locking elements, here in the form of locking linkages 115A and 115B.

Via guiding devices 103A and 103B provided on both doors 1A and 1B, the platform unit P can be varied in its height. For this purpose, adjusting slides 111A, 112A or 111B, 112B connected in pairs to the platform elements 11A and 11B can be adjusted along the vehicle height direction H via drive spindles of the guiding devices 103A and 103B to be driven by a motor. The horizontal treading and/or loading surface of the platform unit P thus can easily be varied in its height with respect to the entry edge, if necessary, at the bodywork opening O in an electronically controlled way.

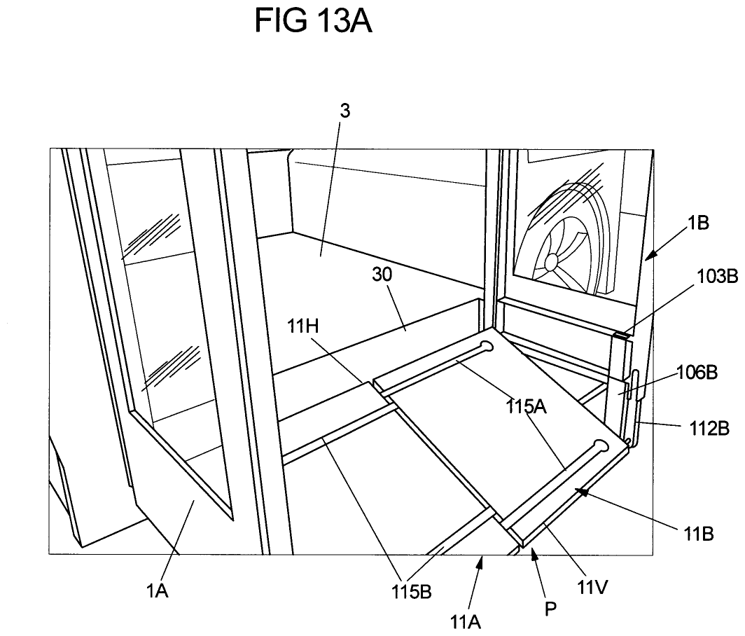

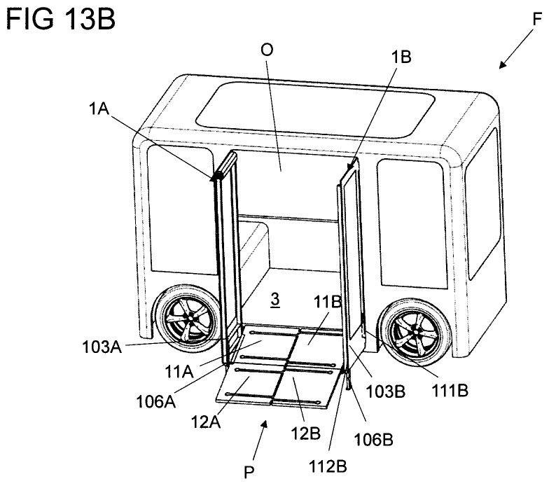

By synchronously adjusting the adjusting slides 111A, 112A and 111B, 112B along the door-side guiding devices 103A and 103B, merely the height of the still horizontally aligned treading and/or loading surface of the platform unit P is changed. As is illustrated with reference to FIGS. 13A and 13B, it is also easily possible, however, to tilt the platform unit P via the guiding device 103A and 103B and thereby form a ramp whose front edge 11V rests on the ground B in front of the entry edge of the bodywork opening O. For this purpose, for example, merely the front adjusting slides 112A and 112B are lowered in the direction of the ground B, while the rear adjusting slides 112A and 112B close to the entry edge remain in their position.

For additionally supporting the doors 1A and 1B or their door leaf elements 10A and 10B swung open, when the platform unit P is held thereon, additional telescopically extendable support elements in the form of support feet 106A and 106B can be provided at the doors 1A and 1B. Via these support feet 106A, 106B, a respective door leaf element 10A and 10B can additionally be supported on the ground B, in particular when the platform unit P is provided. Hence, a load support of the halves of the platform unit P latched to each other is realized via the support feet 106A, 106B, which thereby can be adjusted in their height in the manner of a lifting platform.

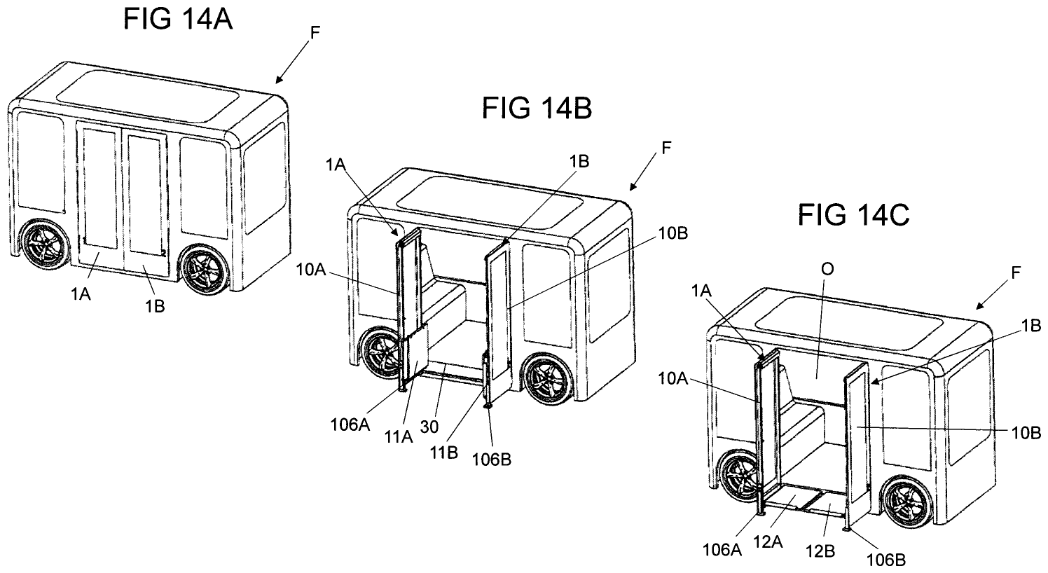

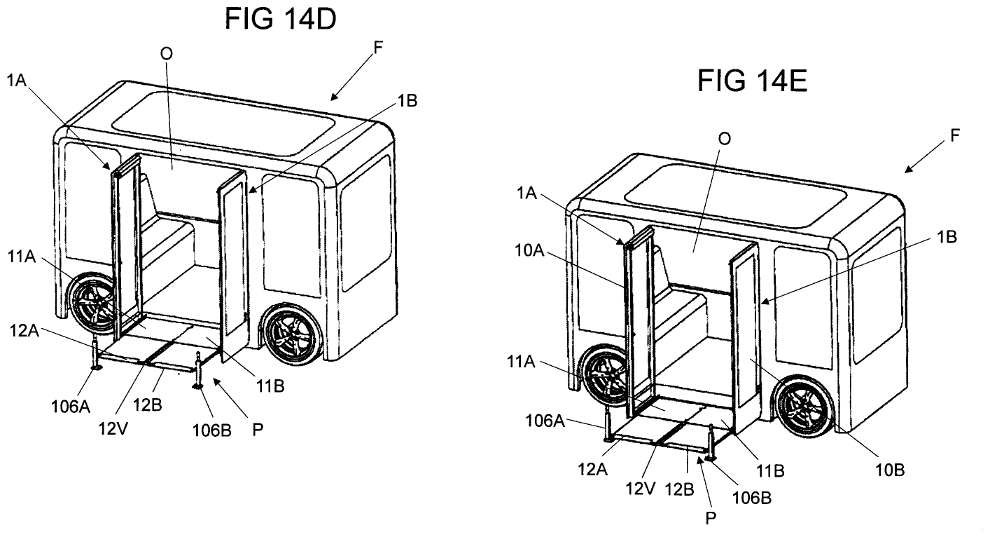

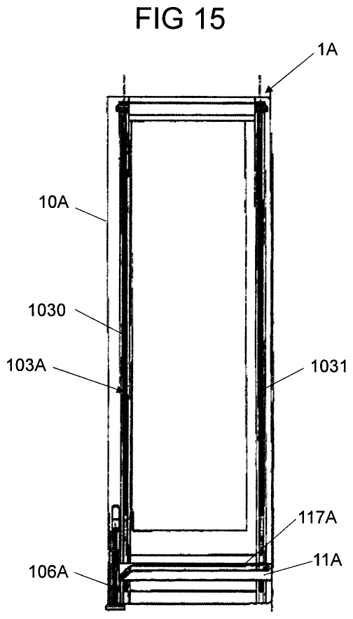

As is illustrated with reference to the design variant of FIGS. 14A to 14E and 15, such support feet 106A, 106B can also be provided on an extendable auxiliary element 12A or 12B of the platform unit P. Via the support feet 106A, 106B, the platform unit P consequently can additionally be supported on the ground B in a front region remote from the entry edge of the bodywork opening O.

As is shown in particular in the side view of FIG. 15, an auxiliary element 12A or 12B is translationally shiftably mounted on a platform element 11A or 11B to be folded down from the respective door leaf element 10A or 10B. For this purpose, the platform element 11A or 11B includes a guide link designated with reference numeral 117A, which is shown in FIG. 15 for the one platform element 11A. For extending the auxiliary element 12A, 12B along the respective guide link, a support foot 106A or 106B fixed thereto is also extended to the front, in order be placed onto the ground B with a distance to the door leaf element 10A or 10B.

In the design variant of FIGS. 14A to 14E and 15, the platform unit P also is height-adjustable in its position of use. Here as well, this is achieved via door-side guiding devices 103A and 103B. Analogously to the drive spindles 200 and 201 at the lateral frame structures in the design variants explained above, door-side guiding devices 103A, 103B also can comprise corresponding drive elements 1030, 1031, e.g. in the form of drive spindles. A motor drive for driving these drive elements 1030 and 1031, which in the variant of FIG. 15 are provided to extend parallel to each other on the long sides of a door leaf element 10A or 10B, for example can comprise a drive motor in a head area of the respective door leaf element 10A or 10B.

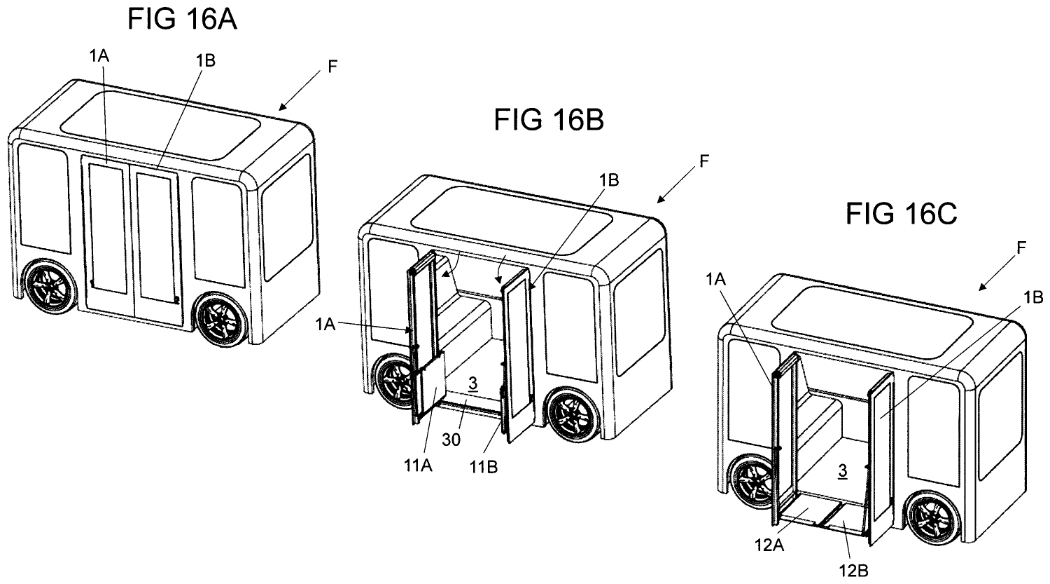

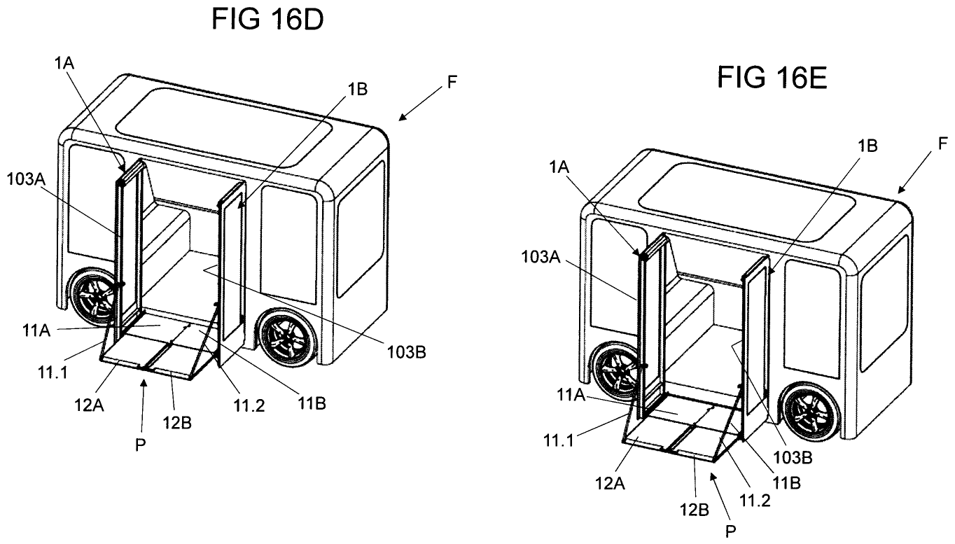

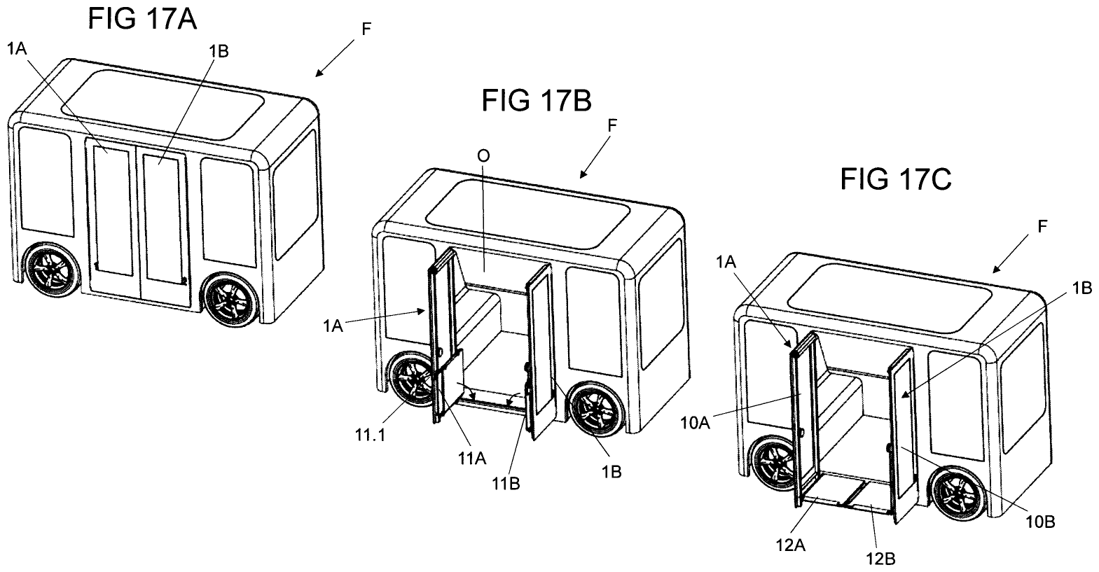

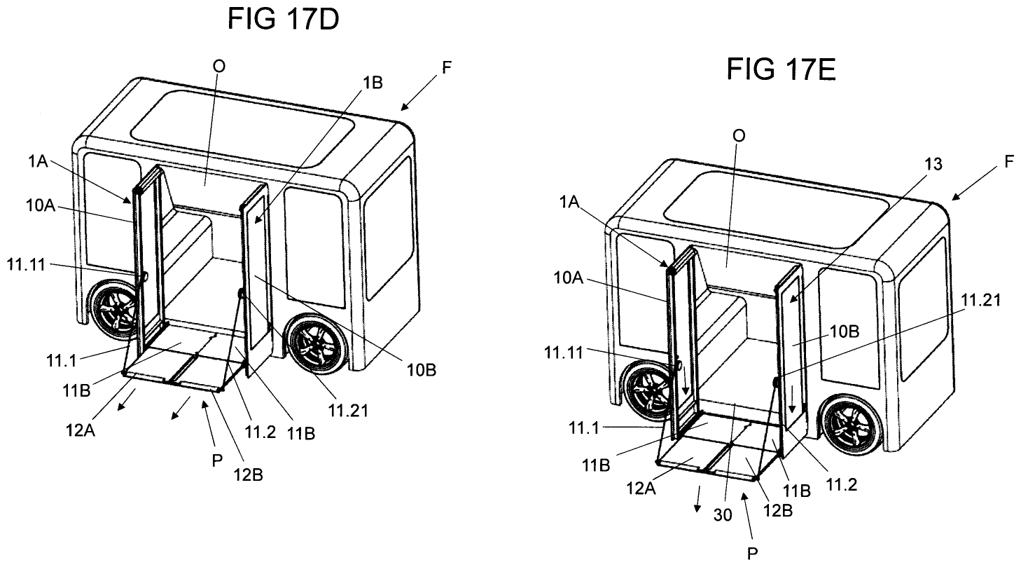

In the design variants of FIGS. 16A to 16E and 17A to 17E, there are provided holding elements 11.1 and 11.2 for stabilizing the position of use of the platform unit P folded out, which each connect the auxiliary elements 12A, 12B to an associated door leaf element 10A or 10B. The holding elements 11.1, 11.2 each are provided for absorbing a tensile load that is to be introduced into the respective door leaf 10A or 10B.

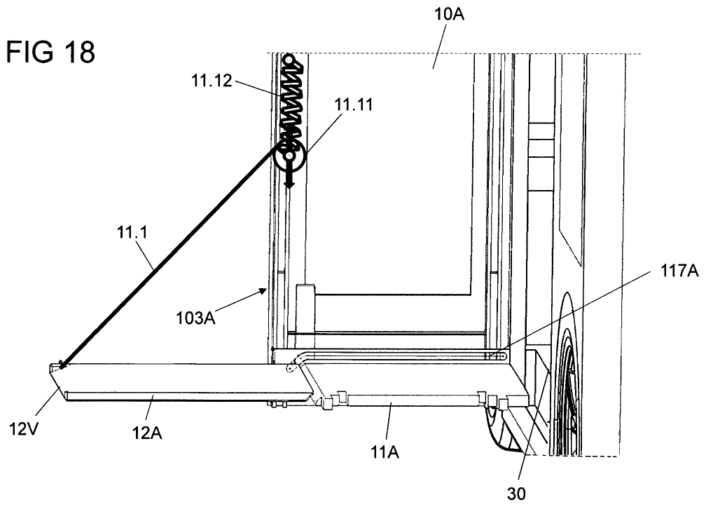

While in the design variant of FIGS. 16A to 16E the holding elements 11.1 and 11.2 each comprise rigid elements, for example rods, the design variant of FIGS. 17A to 17E provides holding elements 11.1 and 11.2 each having a flexible traction means, for example in the form of a (traction) cable. In the design variant of FIGS. 17A to 17E, corresponding to the enlarged detail representation of FIG. 18, a corresponding (traction) cable of a holding element 11.1, 11.2 is held at the associated door leaf element 10A or 10B via one connecting part each in the form of a bearing roller 11.11 or 11.21. Each bearing roller 11.11 or 11.21 here is mounted so as to be elastically displaceable via a spring element in the form of a tension spring. For the one door 1A, this is illustrated in more detail in FIG. 18 with reference to a tension spring 11.12. In this way, an additional fixture comprising a holding element 11.1 or 11.2 is provided at a front edge 12V of an extended auxiliary element 12A or 12B, which is elastically mounted on the associated door leaf element 10A or 10B.

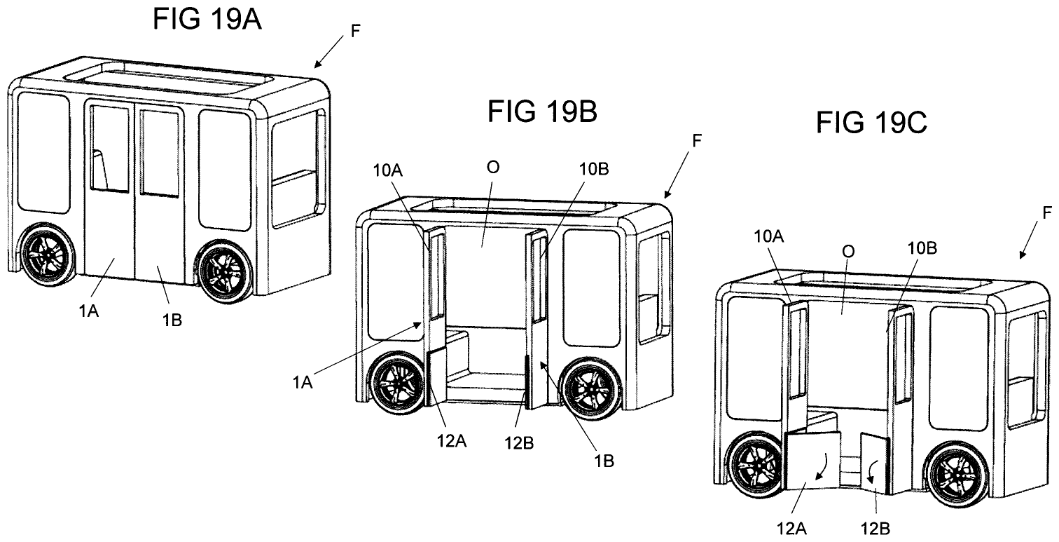

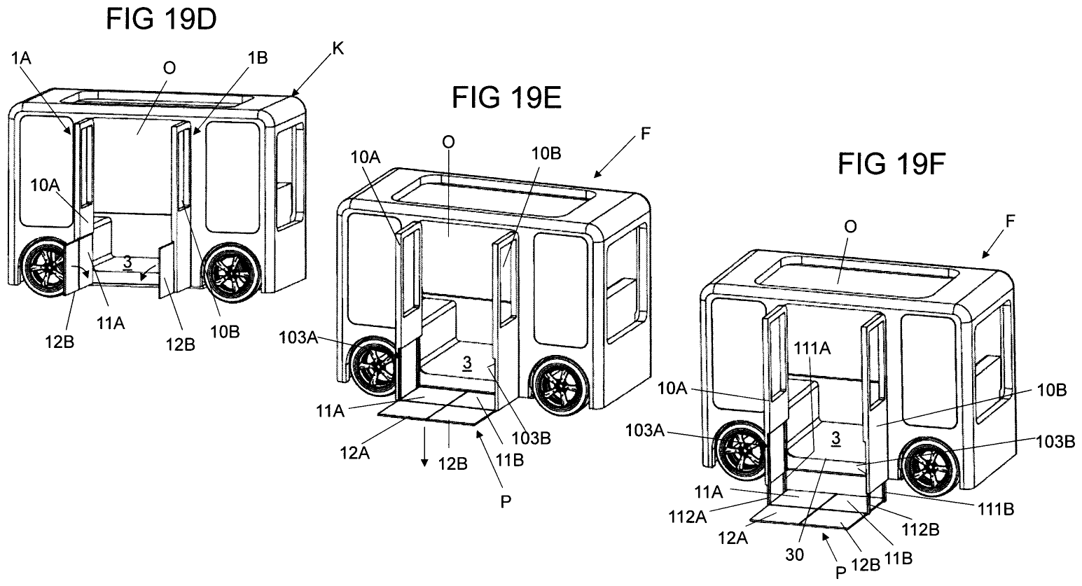

In the design variant of FIGS. 19A to 19F, the auxiliary elements 12A and 12B initially are each pivoted outwards about a pivot axis parallel to the vehicle height direction H at the doors 1A and 1B swung open into the respective opening position. Subsequently, the associated platform elements 11A and 11B—together with the auxiliary elements 12A and 12B—are folded towards each other each about a pivot axis extending transversely to the vehicle longitudinal direction L. The elements 11A to 12B, which are then folded towards each other corresponding to FIG. 19E, then are interlocked in the illustrated second adjustment position in order to form a rigid, continuous treading and/or loading surface for the platform unit P. This treading and/or loading surface of the platform unit P again can be adjusted in its height via the drives integrated into the doors 1A and 1B.

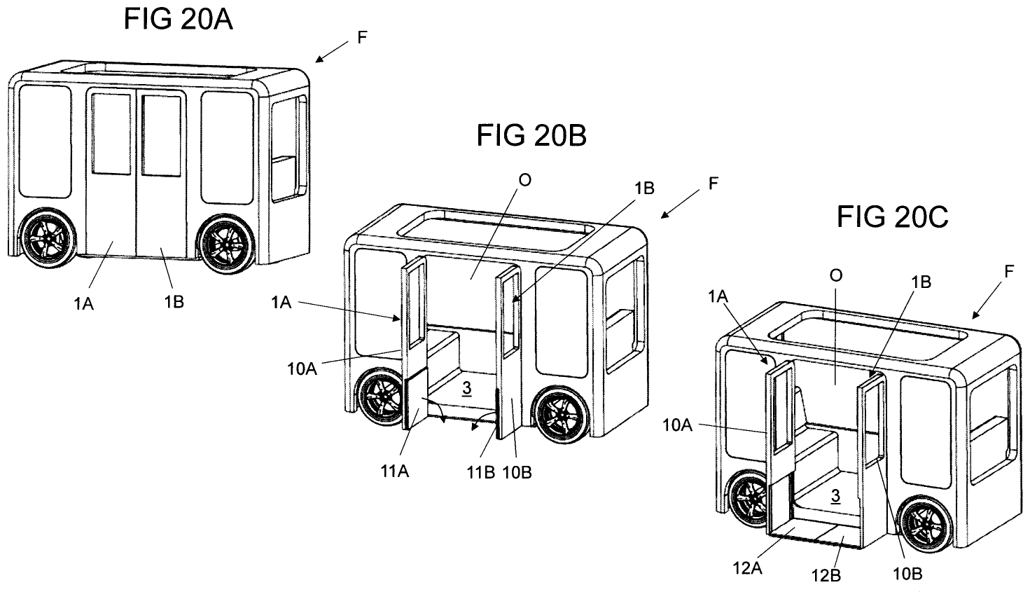

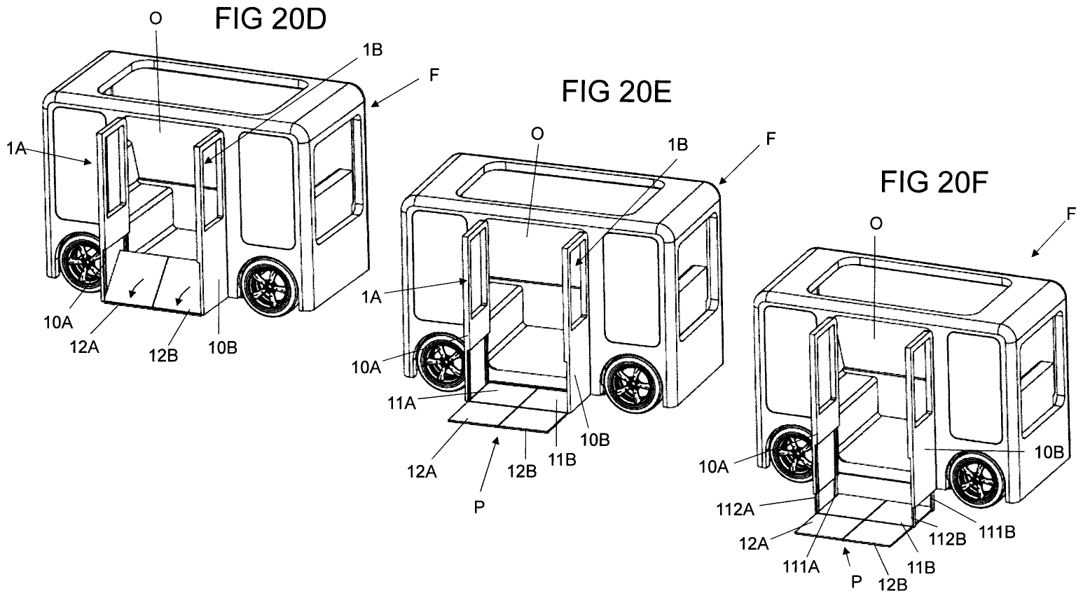

In the design variant of FIGS. 20A to 20F, the platform unit P is disposed in its position of use analogously to the design variant of FIGS. 19A to 19F. Merely the order of the folding and pivoting movements is different. In the design variant of FIGS. 20A to 20F there is initially provided a pivoting movement of the platform elements 11A and 11B towards each other, before the auxiliary elements 12A and 12B subsequently are folded outwards.

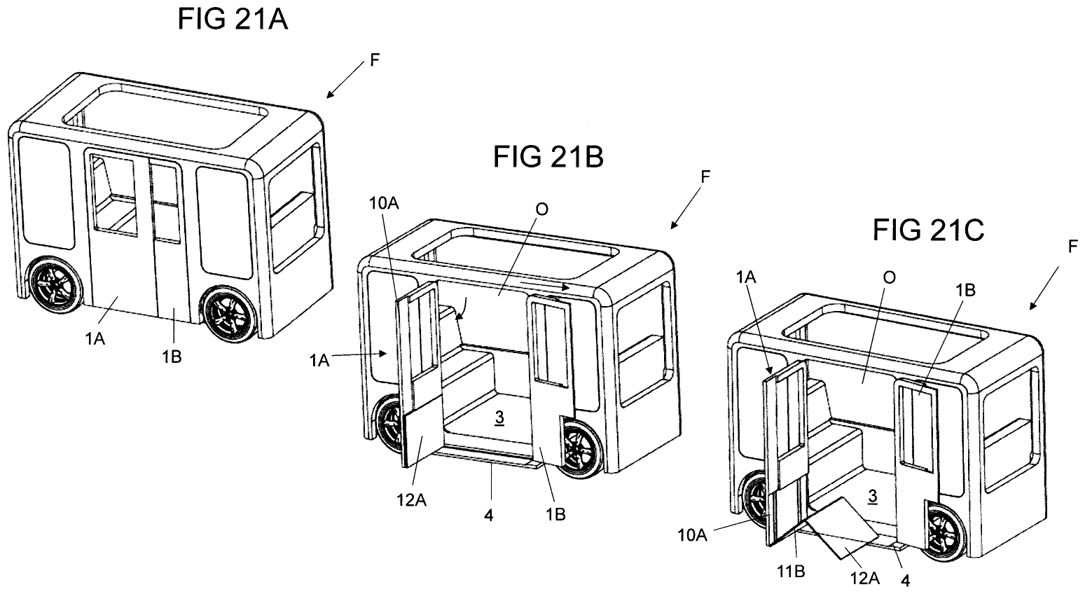

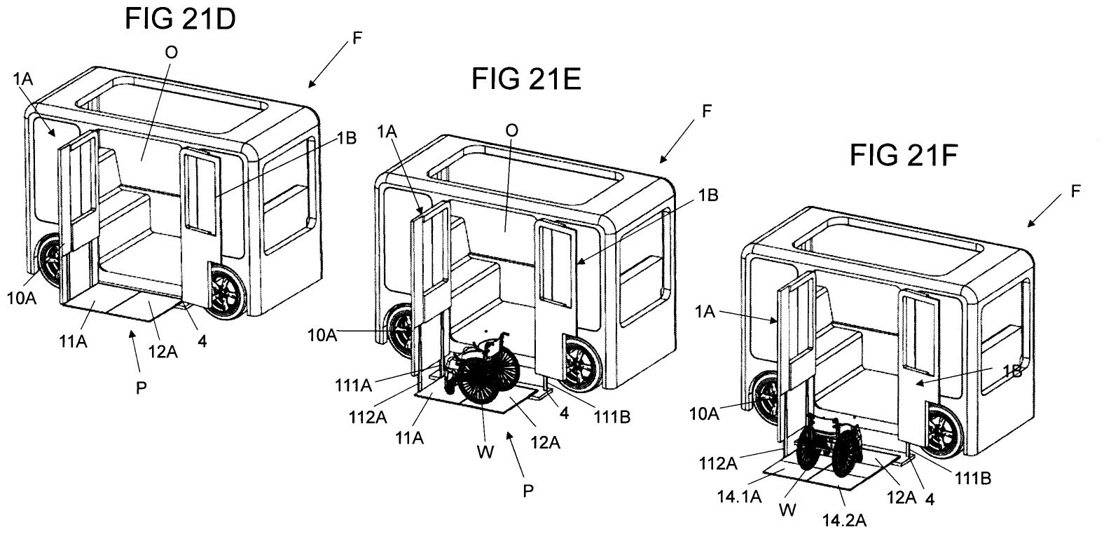

In the design variant of FIGS. 21A to 21F two doors 1A and 1B again are provided for closing the bodywork opening O. Here, a door 1A (the left one in the FIGS.) can be swung open into an opening position about a pivot axis parallel to the vehicle height direction H. This door 1A carries a platform element 11A at a door leaf element 10A as well as an auxiliary element 12A pivotally mounted thereon for forming a platform unit P. The treading and/or loading surface of the platform unit P here can additionally be increased, if necessary, via additional extension pieces 14.1A, 14.2A, which in the present case can be folded out from the platform element 11A and the auxiliary element 12A. The opposite second (right) door 1B in the present case can be shifted substantially parallel to the vehicle longitudinal direction L and does not carry a part of the platform unit P that would define a treading and/or loading surface. There is again provided an adjustment drive by means of which the platform unit P disposed in a position of use corresponding to FIGS. 21D, 21E and 21F can be varied in its height when the platform elements and auxiliary elements 11A and 12A have been folded out about their pivot axes extending parallel to each other and each transversely to the vehicle longitudinal direction L. An edge region close to the entry edge of the platform unit P disposed in the position of use rests on a longitudinally extended support element 4 extending below the entry edge. This support element 4 can be adjusted along the vehicle height direction H via body-side adjustment slides 111A and 111B in the region of the two vehicle doors 1A and 1B. As this adjustment is effected synchronously to an adjustment of a front adjustment slide 112A of the first door 1, to which the platform element 11A is fixed, the platform unit P comprising a horizontally extending treading and/or loading surface can be translationally adjusted, for example in order to thereby be able to lift a wheelchair W to the height of the entry edge in the manner of a lifting platform.

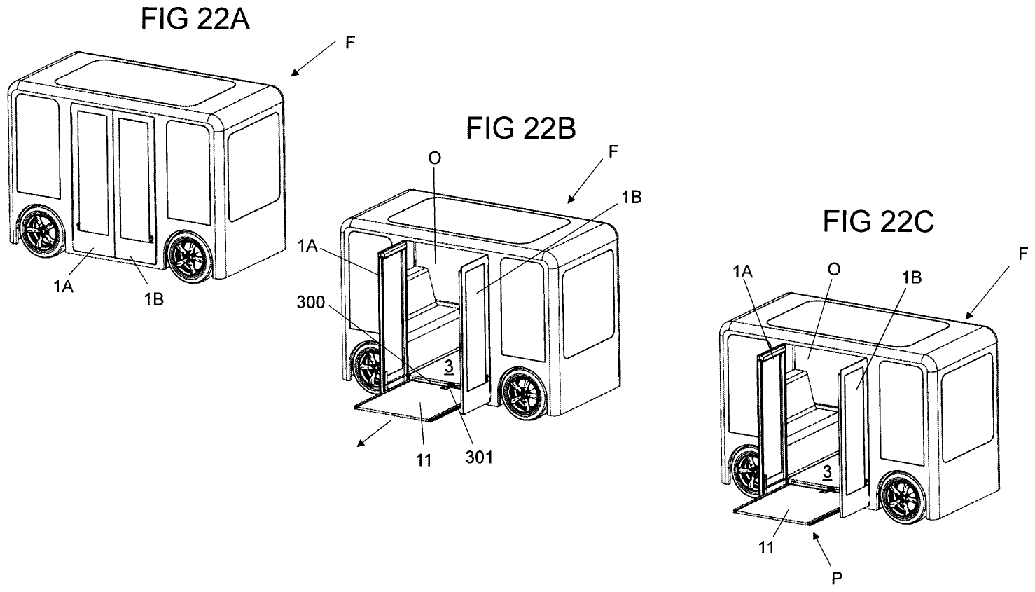

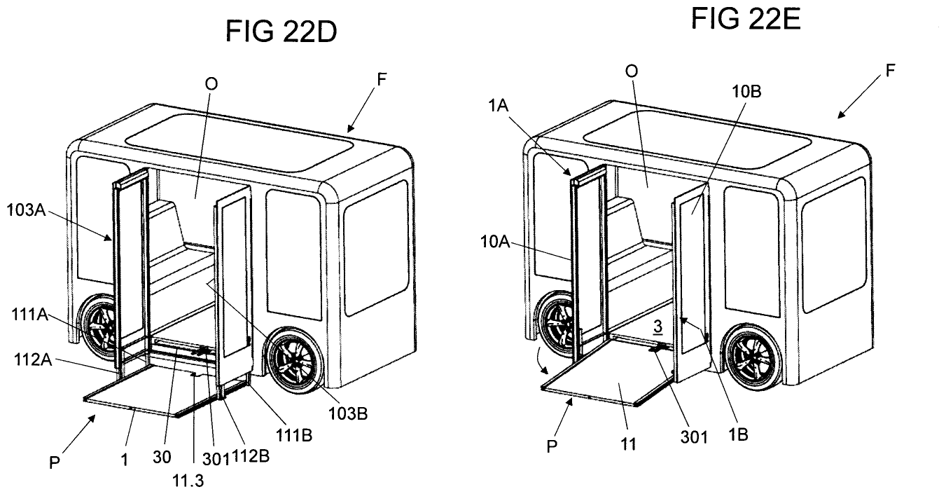

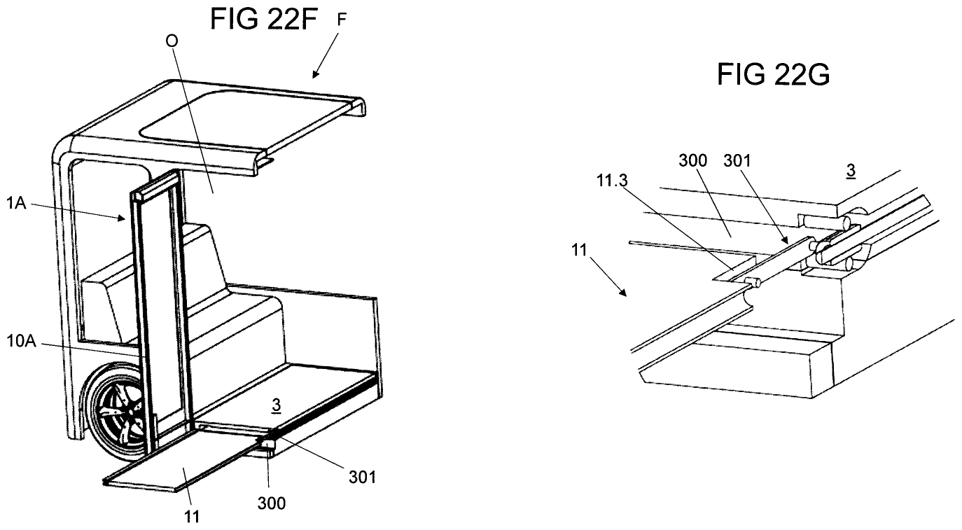

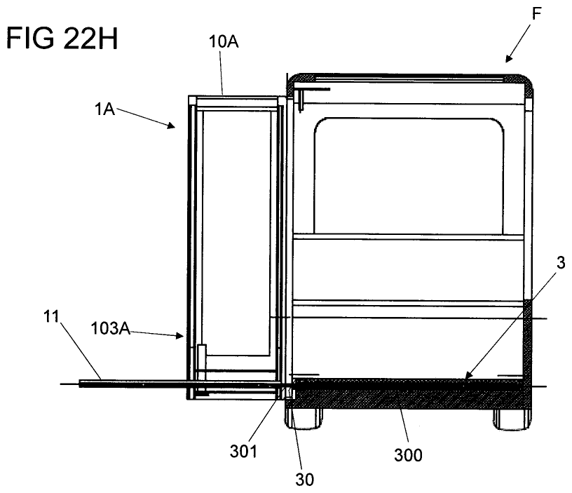

FIGS. 22A to 22E illustrate another design variant of a proposed vehicle F according to the proposed solution. In the illustrated vehicle F, two doors 1A and 1B to be swung open in mutually opposite directions are again provided for closing the bodywork opening O. In a respective opening position, these doors 1A and 1B define a guide for a platform element 11 extendable from a stowage space 300 below the floor element 3. For retracting and extending the platform element 11, there is provided a motor-driven adjuster 301 comprising an adjusting linkage, which is accommodated in the stowage space 300. This is illustrated in more detail in particular with reference to the additional representations of FIGS. 22F, 22G and 22H.

The adjuster 301 is releasably connected to the platform element 11 via an interface 11.3. In this way, the platform element 11 can be translationally extended and retracted again via the adjuster 301, when the doors 1A and 1B have been pivoted outwards by 90° about their respective pivot axis parallel to the vehicle height direction H. In particular on extension from the stowage space 33, an extending part of the platform element 11 is supported on guides of a door leaf element 10A, 10B of the open doors 1A and 1B. These guides are connected to adjustment slides 111A, 111B and 112A, 112B of door-side guiding devices 103A and 103B.

When the platform element 11 is maximally extended into a second adjustment position and thereby defines a position of use of a platform unit P, so that a treading and/or loading surface provided by the extended platform element 11 is available in front of an entry edge of the bodywork opening O, the position of the platform unit P can be varied via the adjustment slides 111A to 112B of the guiding devices 103A, 103B. When merely the two foremost adjustment slides 112A and 112B are lowered, the platform unit P is tilted in order to define a ramp (cf. FIG. 22E). When all four adjustment slides 111A to 112B are synchronously adjusted downwards in the direction of the ground B, the platform unit P can be lowered completely. In doing so, a connection to the adjuster 301 is released at the interface 11.3. The connection to the adjuster 301 is restored automatically when the platform unit P is returned into the starting position and hence is lifted. Via the adjuster 301, the platform element 11 can then be pulled back again into the vehicle-side stowage space 300.

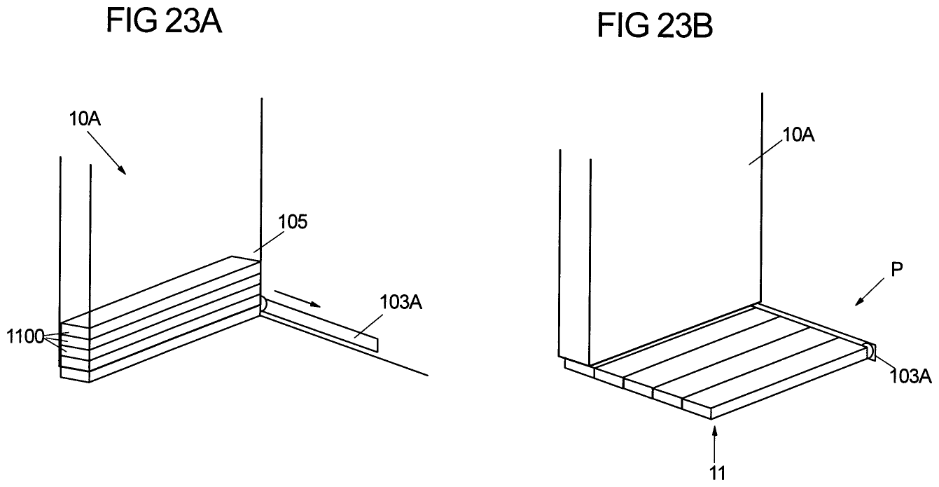

In the merely sectionally represented design variant of FIGS. 23A and 23B, a platform element 11 can be accommodated completely within a door-side stowage space 105 of a door leaf element 10A, when no platform unit P is needed. The platform element 11 here is formed by a plurality of interconnected segments 1100, which can be arranged one above the other within the stowage space 105. When the vehicle door 1A is open and hence pivoted outwards by 90° at the vehicle F, a guiding device 103A of the door leaf element 10A can be folded out or extended. For example, the guiding device 103A therefor comprises a longitudinally extended guide arm. Via this guide arm of the guiding device 103A, a physical guidance then is provided for the segments 1100 of the platform element 11A extending from the stowage space 105 in a power-operated way. In this way, the platform element 11 can be extended from the door leaf element 10A substantially parallel to the vehicle longitudinal direction L, in order to provide the platform unit P with its treading and/or loading surface in front of the entry edge of the bodywork opening O.

### LIST OF REFERENCE NUMERALS

1, 1A, 1B door
10, 10A, 10B door leaf element
10.1, 10.2 guide element
100 coupling interface
101, 102 adjustment slide (adjustment element)
1030, 1031 drive element
103A, 103B guiding device
105 stowage space
106A, 106B support foot (support element)
11, 11A, 11B lower door part/platform element
11.1, 11.2 holding element
11.11, 11.21 bearing roller (connecting part)
11.12 tension spring (spring element)
11.3 interface
1100 segment
111, 111A, 111B adjustment slide (adjustment element)
112, 112A, 112B adjustment slide (adjustment element)
115A, 115B locking linkage (locking element)
117A guide link
11H rear edge
11V front edge
12, 12′, 12″, auxiliary element
12A, 12B
12V front edge
13 roof part
14.1A, 14.2A extension piece
2.1, 2.2 guide rail
200, 201 drive spindle (drive element)
21, 22 articulated lever
3 floor element
30 front edge/entry edge
300 stowage space
301 adjuster
31 trim
4 support member (support element)
5A, 5B connecting element
B ground
F vehicle
H vehicle height direction
L vehicle longitudinal direction
O bodywork opening
P platform unit
W wheel chair (object to be loaded)

1. A vehicle, comprising
a bodywork opening, which can at least partially be closed by at least one door disposed in a closing position, and
a flat platform unit, which is provided to facilitate access into the vehicle via the bodywork opening, when the at least one door is disposed in an opening position,
wherein at least part of the flat platform unit is formed by at least one adjustable, flat platform element, which
a) forms part of the at least one door, which in the closing position closes at least part of the bodywork opening, or
b) in at least one adjustment position, is at least one of fixed to and supported on a component of the at least one door.

2. The vehicle according to claim 1, wherein the at least one platform element can be adjusted at least between a first adjustment position and a second adjustment position, wherein in the first adjustment position the platform element cannot be used to facilitate access into the vehicle, and via the platform element disposed in the second adjustment position a position of use of the platform unit is defined, in which the platform element can be used to facilitate access into the vehicle.

3. The vehicle according to claim 2, wherein in the position of use of the platform unit a position of the platform unit can be varied by adjusting the at least one platform element into at least one third adjustment position.

4. The vehicle according to claim 2, wherein the platform unit with a rear region faces a front edge of a floor element provided in the vehicle interior of the vehicle and adjoining the bodywork opening, and on the platform unit at least one support element is provided, via which the platform unit disposed in the position of use in a front region can be supported on a ground present outside the vehicle.

5. (canceled)

6. The vehicle according to claim 1, wherein the at least one platform element can be pivoted about a pivot axis which extends parallel to a vehicle longitudinal direction of the vehicle pointing from a vehicle rear to a vehicle front, or which extends perpendicularly to the vehicle longitudinal direction.

7. The vehicle according to claim 1, wherein the platform unit furthermore is formed by at least one flat auxiliary element, which is pivotally or translationally adjustably mounted on the at least one platform element.

8. (canceled)

9. The vehicle according to claim 1, wherein the platform unit with a rear region faces a front edge of a floor element provided in an interior space of the vehicle and adjoining the bodywork opening, and there is provided at least one holding element via which a front region of the platform unit spaced apart from the rear region in a spatial direction pointing away from the front edge is connected to a frame portion of the vehicle bordering the bodywork opening or to the at least one door.

10. The vehicle according to claim 7, wherein the platform unit with a rear region faces a front edge of a floor element provided in an interior space of the vehicle and adjoining the bodywork opening, and there is provided at least one holding element via which a front region of the platform unit spaced apart from the rear region in a spatial direction pointing away from the front edge is connected to a frame portion of the vehicle bordering the bodywork opening or to the at least one door, wherein in the front region of the platform unit the at least one holding element is connected to the auxiliary element or to the platform element.

11. (canceled)

12. (canceled)

13. The vehicle according to claim 1, wherein the at least one platform element as part of the at least one door or fixed to the at least one door can also be displaced when the at least one door is adjusted from the closing position into the opening position.

14. The vehicle according to claim 1, wherein for at least partially closing the one bodywork opening at least two doors are provided.

15. (canceled)

16. The vehicle according to claim 1, wherein the platform element, which in the closing position of the at least one door closes at least part of the bodywork opening, can be adjusted separately from at least one flat door leaf element of the door, which in the closing position closes at least part of the bodywork opening together with the platform element.

17. The vehicle according to claim 16, wherein the door leaf element, based on a vehicle height direction pointing from a vehicle floor to a vehicle roof of the vehicle, forms an upper part of the at least one door and the platform element forms a lower part of the at least one door.

18. The vehicle according to claim 17, wherein, for providing the platform unit, the at least one platform element can be adjusted downwards with at least one directional component with respect to the vehicle height direction and the door leaf element can separately be adjusted sidewards on the vehicle, upwards or transversely to the vehicle height direction.

19. The vehicle according to claim 16, wherein the platform element can be adjusted into a stowage space position in which the platform element is at least partially present below a vehicle-side floor element that defines a floor surface of an interior space of the vehicle.

20. (canceled)

21. (canceled)

22. (canceled)

23. (canceled)

24. The vehicle according to claim 1, wherein the at least one platform element
b1) in the closing position, is fixed to the component of the at least one door in a first adjustment position and can be adjusted from the first adjustment position into a second adjustment position, or
b2) in the opening position, is guided on a guiding device of the component of the at least one door and can be adjusted when supported thereon.

25. (canceled)

26. (canceled)

27. The vehicle according to claim 24, wherein the platform element can be extended from a vehicle-side stowage space transversely to a vehicle longitudinal direction of the vehicle pointing from a vehicle rear to a vehicle front, and can be supported on the door disposed in the opening position via at least one guiding device, when the platform element is extended from the vehicle-side stowage space transversely to the vehicle longitudinal direction.

28. The vehicle according to claim 24, wherein the platform element can be extended from a door-side stowage space parallel to a vehicle longitudinal direction of the vehicle pointing from a vehicle rear to a vehicle front and can be supported on the door disposed in the opening position via at least one guiding device, when the platform element is extended from the door-side stowage space parallel to the vehicle longitudinal direction.

29. (canceled)

30. (canceled)

31. (canceled)

32. (canceled)

33. (canceled)

34. (canceled)

35. A vehicle, comprising
a bodywork opening, which can at least partially be closed by at least one door disposed in a closing position,
a floor element within an interior space of the vehicle, which is accessible via the bodywork opening when the door is open, and with a front edge adjoins the bodywork opening, and
a flat platform unit, which is provided to facilitate access into the vehicle via the bodywork opening below or at the front edge of the floor element, when the at least one door is disposed in an opening position,
wherein at least part of the flat platform unit is formed by at least one adjustable, flat platform element which, based on a vehicle height direction pointing from a vehicle floor to a vehicle roof of the vehicle, can be adjusted into an adjustment position above the front edge of the floor element.

36. The vehicle according to claim 1, wherein the at least one platform element is adapted and provided for the provision of a drone landing surface at the vehicle.

37. The vehicle according to claim 35, wherein the at least one platform element is adapted and provided for the provision of a drone landing surface at the vehicle.
